(19) United States
(12) Patent Application Publication
(10) Pub. No.: US 2026/0118470 A1
(43) Pub. Date: Apr. 30, 2026

(54) METHOD AND DEVICE FOR CLASSIFYING POSE BY USING ULTRA WIDEBAND COMMUNICATION SIGNAL

(71) Applicant: SAMSUNG ELECTRONICS CO., LTD., Suwon-si, Gyeonggi-do (KR)

(72) Inventors: Junyoung CHOI, Suwon-si (KR); Sagnik BHATTACHARYA, Suwon-si (KR)

(21) Appl. No.: 19/102,290

(22) PCT Filed: Sep. 22, 2023
(86) PCT No.: PCT/KR2023/014568

§ 371 Date: Feb. 7, 2025

(30) Foreign Application Priority Data
Sep. 23, 2022 (KR) 10-2022-0120853
Oct. 6, 2022 (KR) 10-2022-0128163

(51) Int. Cl. G01S 5/02; G06N 3/0464

(52) U.S. Cl. CPC G01S 5/02585; G01S 5/0247; G06N 3/0464

(57) ABSTRACT

The present disclosure provides a method by which an electronic device classifies a pose by using a UWB signal. The method of the present disclosure may comprise the steps of: using a trained first CNN model so as to acquire first prediction data for classifying whether a signal corresponding to a UWB CIR is a LOS signal or an NLOS signal on the basis of UWB CIR data; using, if the signal is classified as the LOS signal, a trained second CNN model so as to acquire second prediction data for classifying a pose on the basis of sensor data corresponding to the UWB CIR data; using, if the signal is classified as the NLOS signal, a trained third CNN model so as to acquire third prediction data for classifying the pose on the basis of the sensor data corresponding to the UWB CIR data; using a first filtering method so as to filter at least two from among the first prediction data, the second prediction data, and the third prediction data; and classifying the pose on the basis of the filtered data.

### CROSS-REFERENCE TO RELATED APPLICATIONS

This application is a U.S. National Phase Entry of PCT International Application No. PCT/KR2023/014568, which was filed on Sep. 22, 2023, and claims priority to Korean Priority Patent Application No. 10-2022-0120853 filed on Sep. 23, 2022, and claims priority to Korean Priority Patent Application No. 10-2022-0128163 filed on Oct. 6, 2022, in the Korean National Intellectual Property Administration, the contents of which are incorporated herein by reference.

### TECHNICAL FIELD

The disclosure relates to a method and apparatus for classifying a pose using a UWB signal.

In addition, the disclosure relates to a method and apparatus for estimating a position of an electronic device using a UWB signal.

### BACKGROUND ART

The Internet, which is a human centered connectivity network where humans generate and consume information, is now evolving to the Internet of things (IoT) where distributed entities, such as things, exchange and process information. The Internet of everything (IoE), which is a combination of the IoT technology and the big data processing technology through a connection with a cloud server, etc. has emerged. As technology elements, such as “sensing technology”, “wired/wireless communication and network infrastructure”, “service interface technology”, and “security technology” have been demanded for IoT implementation. Recently, a sensor network, a machine-to-machine (M2M) communication, machine type communication (MTC), and so forth have been researched.

Such an IoT environment may provide intelligent Internet technology (IT) services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

### DETAILED DESCRIPTION OF THE INVENTION

### Technical Problem

The disclosure provides a method of classifying a signal as a line of sight (LOS)/non-LOS (NLOS) signal by using UWB channel impulse response (CIR) data.

In addition, the disclosure provides a method of classifying a pose by using a signal classification result and sensor data.

In addition, the disclosure provides a method of classifying a UWB signal as a line of sight (LOS)/non-LOS (NLOS) signal, and estimating a position of an electronic device based on a classification result.

### Technical Solution

According to various embodiments of the disclosure, a method of an electronic device may include an operation of obtaining first predicted data for classifying whether a signal corresponding to a UWB channel impulse response (UWB CIR) is a line of signt (LOS) signal or a non-LOS (NLOS) signal based on UWB CIR data, by using a trained first convolutional neural network (CNN) model, an operation of obtaining second predicted data for classifying a pose based on sensor data corresponding to the UWB CIR data, by using a trained second CNN model when the signal is classified as the LOS signal, an operation of obtaining third predicted data for classifying a pose based on sensor data corresponding to the UWB CIR data, by using a trained third CNN model when the signal is classified as the NLOS signal, an operation of performing filtering of at least two of the first predicted data, the second predicted data, and the third predicted data by using a first filtering scheme, and an operation of classifying the pose based on the filtered data, wherein the second CNN model may be trained using sensor data associated with the LOS signal, and the third CNN model may be trained using sensor data associated with the NLOS signal.

According to various embodiments of the disclosure, an electronic device may include a transceiver and a controller connected to the transceiver, wherein the controller may be configured to obtain first predicted data for classifying whether a signal corresponding to a UWB channel impulse response (CIR) is a line of signt (LOS) signal or a non-LOS (NLOS) signal based on UWB CIR data, by using a trained first convolutional neural network (CNN) model, to obtain second predicted data for classifying a pose based on sensor data corresponding to the UWB CIR data, by using a trained second CNN model when the signal is classified as the LOS signal, to obtain third predicted data for classifying a pose based on sensor data corresponding to the UWB CIR data, by using a trained third CNN model when the signal is classified as the NLOS signal, to perform filtering of at least two of the first predicted data, the second predicted data, and the third predicted data by using a first filtering scheme, and to classify the pose based on the filtered data, wherein the second CNN model may be trained using sensor data associated with the LOS signal and the third CNN model may be trained using sensor data associated with the NLOS signal.

According to an embodiment of the disclosure, a method of an electronic device may include an operation of identifying an average of line of sight (LOS) probabilities for a plurality of received UWB signals. The method of the electronic device may include an operation of comparing the average of LOS probabilities of the plurality of received UWB signals with a first threshold value, and determining whether a DL-TDoA environment is an LOS environment based on a comparison result. The method of the electronic device may include an operation adaptively adjusting a ranging frequency that the electronic device uses for ranging when it is determined that the DL-TDoA environment is the LOS environment. Each of the plurality of received UWB signals may include a UWB message for DL-TDoA positioning.

According to various embodiments of the disclosure, an electronic device may include a transceiver and a controller connected to the transceiver. The controller may identify an average of line of sight (LOS) probabilities for the plurality of received UWB signals. The controller may compare the average of LOS probabilities of the plurality of received UWB signals with a first threshold value, and may determine whether the DL-TDoA environment is an LOS environment based on a comparison result. When it is determined that the DL-TDoA environment is the LOS environment, the controller may adaptively adjust a ranging frequency that the electronic device uses for ranging. Each of the plurality of received UWB signals may include a UWB message for DL-TDoA positioning.

### Advantageous Effects

According to the method of the disclosure, the accuracy of LOS/NLOS signal classification may be increased.

In addition, according to the method of the disclosure, the accuracy of pose classification may be increased.

In addition, according to the method of the disclosure, the accuracy of position estimation associated with an electronic device by using a UWB signal may be increased.

In addition, according to the method of the disclosure, power, consumed when a position of an electronic device is estimated using a UWB signal, may be decreased.

### BRIEF DESCRIPTION OF DRAWINGS

FIG. 1 is a block diagram schematically illustrating an electronic device;

FIG. 2A is a diagram illustrating an architecture of a UWB device according to an embodiment of the disclosure;

FIG. 2B is a diagram illustrating a configuration of a framework of a UWB device according to an embodiment of the disclosure;

FIG. 3A is a diagram illustrating an example of UWB CIR data according to an embodiment of the disclosure;

FIG. 3B is a diagram illustrating an example of effective UWB CIR data according to an embodiment of the disclosure;

FIG. 3C is a diagram illustrating an example of an LOS signal and an NLOS signal classified using UWB CIR data according to an embodiment of the disclosure;

FIG. 4 is a diagram illustrating DS-TWR according to an embodiment of the disclosure;

FIG. 5 is a diagram illustrating a DL-TDoA according to an embodiment of the disclosure;

FIG. 6 is a diagram illustrating a training procedure and a deployment procedure for LOS/NLOS signal classification using UWB channel impulse response data according to an embodiment of the disclosure;

FIG. 7 is a diagram illustrating a configuration of a user device for LOS/NLOS classification according to an embodiment of the disclosure;

FIG. 8 is a diagram illustrating a training procedure for pose classification based on LOS/NLOS signal classification using UWB channel impulse response data according to an embodiment of the disclosure;

FIG. 9 is a diagram illustrating a deployment procedure for pose classification based on LOS/NLOS signal classification using UWB channel impulse response data according to an embodiment of the disclosure;

FIG. 10 is a diagram illustrating a configuration of a user device for pose classification using LOS/NLOS classification according to an embodiment of the disclosure;

FIG. 11 is a diagram illustrating a pose classification method of an electronic device according to an embodiment of the disclosure;

FIG. 12 is a diagram illustrating a structure of an electronic device according to an embodiment of the disclosure;

FIG. 13A is a diagram illustrating a structure of a UWB MAC frame according to an embodiment of the disclosure;

FIG. 13B is a diagram illustrating a structure of a UWB PHY packet according to an embodiment of the disclosure;

FIG. 14 is a diagram illustrating an example of a cluster configured with a plurality of UWB anchors according to an embodiment of the disclosure;

FIG. 15A is a diagram illustrating a method of performing UWB ranging based on a DL-TDoA scheme by a UWB device according to an embodiment of the disclosure;

FIG. 15B is a diagram illustrating an example of a ranging block structure for a downlink TDoA scheme according to an embodiment of the disclosure;

FIG. 16A is a diagram illustrating an example of an LOS environment in the case of DL-TDoA positioning according to an embodiment of the disclosure;

FIG. 16B is a diagram illustrating an example of LOS probability data for a UWB signal obtained in the DL-TDoA positioning environment of FIG. 16A;

FIG. 17A is a diagram illustrating an example of an LOS environment in the case of DL-TDoA positioning according to an embodiment of the disclosure;

FIG. 17B is a diagram illustrating an example of a graph associated with an acceleration value based on a movement of a user device in the DL-TDoA positioning environment of FIG. 17A;

FIG. 18A is a diagram illustrating an example of an NLOS environment in the case of DL-TDoA positioning according to an embodiment of the disclosure;

FIG. 18B is a diagram illustrating an example of LOS probability data for a UWB signal obtained in the DL-TDoA positioning environment of FIG. 18A;

FIG. 19 is a diagram illustrating a configuration of a user device that is capable of reducing power consumption based on LOS/NLOS classification according to an embodiment of the disclosure; and

FIG. 20 is a diagram illustrating a structure of an electronic device according to an embodiment of the disclosure.

### MODE FOR CARRYING OUT THE INVENTION

Hereinafter, embodiments of the disclosure will be described in detail with reference to the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The instructions which execute on a computer or other programmable data procesisng apparatus to cause a series of operational steps to be performed on the computer or other programmable data processing apparatus to produce a computer implemented process may provide steps for implementing the functions specified in the flowchart block(s).

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in various embodiments of the disclosure may include one or more processors.

As used herein, the term “terminal” or “device” may also be referred to as a mobile station (MS), a user equipment (UE), a user terminal (UT), a wireless terminal, an access terminal (AT), a terminal, a subscriber unit, a subscriber station (SS), a wireless device, a wireless communication device, a wireless transmit/receive unit (WTRU), a mobile node, a mobile, or other terms. Various examples of the terminal may include a cellular phone, a smartphone having a wireless communication function, a personal digital assistant (PDA) having a wireless communication function, a wireless modem, a portable computer having a wireless communication function, a photographing device such as a digital camera having a wireless communication function, a gaming device having a wireless communication function, a music storage and playback home appliance having a wireless communication function, an Internet hole appliance capable of wireless Internet access and browsing, and portable units or terminals having integrated combinations of these functions. Furthermore, the terminal may include a machine to machine (M2M) terminal, and a machine type communication (MTC) terminal/device, but is not limited thereto. In the specification, the terminal may also be referred to as an electronic device or simply as a device.

Hereinafter, the operation principle of the disclosure will be described in detail in conjunction with the accompanying drawings. In the following description of the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

Hereinafter, embodiments of the disclosure will be described in detail in conjunction with the accompanying drawings. In the following description of embodiments of the disclosure, a communication system using a UWB will be described by way of example, but the embodiments of the disclosure may be applied to other communication systems having similar technical backgrounds or characteristics. Examples thereof may include communication systems using Bluetooth or Zigbee. Therefore, based on determinations by those skilled in the art, the embodiments of the disclosure may be applied to other communication systems through some modifications without significantly departing from the scope of the disclosure.

Also, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

Generally, wireless sensor network technology is classified as wireless local area network (WLAN) technology and wireless personal area network (WPAN) technology, briefly, based on a recognition distance. In this instance, WLAN is technology based on IEEE 802.11, and enables access to a backbone network within a radius of approximately 100 m. WPAN is technology based on IEEE 802.15, and includes Bluetooth, ZigBee, ultra wide band (UWB), or the like. A wireless network in which those wireless network technologies are embodied may include a plurality of electronic devices.

According to the definition by federal communications commission (FCC), UWB is wireless communication technology that uses a bandwidth of 500 MHz or more, or of which least 20% of the bandwidth corresponds to a central frequency. UWB may be a bandwidth itself to which UWB communication is applied. UWB allows secure and accurate ranging between devices. Through the above, UWB may enable relative position estimation based on a distance between two devices, or may enable accurate position estimation of a device based on distances from stationary devices (of which positions are known).

Predetermined terms used in the descriptions provided below are provided to help understanding of the disclosure, and those terms may be changed to others without departing from the scope of technical idea of the disclosure.

“Application dedicated file (ADF)” is a data structure in an application data structure that is capable of hosting an application or application specific data.

“Application protocol data unit (APDU)” is a command and a response used in the case of communication with an application data structure in a UWB device.

“Application specific data”, for example, may be a file structure having a root level and an application level including UWB control information and UWB session data required for a UWB session.

“Controller” may be a ranging device that defines and controls ranging control messages (RCM) (or control message). The controller may define and control ranging features by transmitting a control message.

“Controlee” may be a ranging device that uses a ranging parameter in an RCM (or control message) received from a controller. The controlee may use ranging features which are the same as those configured by the controller via a control message.

“Dynamic scrambled timestamp sequence (STS) mode” may be an operation mode in which an STS is not repeated during a ranging session, unlike “static STS”. In this mode, an STS is managed by a ranging device, and a ranging session key that generates an STS may be managed by a secure component.

“Applet”, for example, may be an applet executed in a secure component including UWB parameters and service data. The applet may be an FiRa applet.

“Ranging device” may be a device capable of performing UWB ranging. In the disclosure, the ranging device may be an enhanced ranging device (ERDEV) or FiRa device defined by IEEE 802.15.4z. The ranging device may be referred to as a UWB device.

“UWB-enabled application” may be an application for a UWB service. For example, the UWB-enabled application may be an application that uses a framework API for configuring an OOB connector, a secure service, and/or a UWB service for a UWB session. “UWB-enabled application” may be referred to as an application or a UWB application for short. The UWB-enabled application may be a FiRa-enabled application.

“Framework” may be a component that enables access to a profile, and provides an individual UWB configuration and/or notification. The framework, for example, may be a collection of logical software components including a profile manager, an OOB connector, a secure service, and/or a UWB service. The framework may be a FiRa framework.

“OOB connector” may be a software component for configuring an out-of-band (OOB) connection (e.g., BLE connection) between ranging devices. The OOB connector may be a FiRa OOB connector.

“Profile” may be a predefined set of UWB and OOB configuration parameters. The profile may be a FiRa profile.

“Profile manager” may be a software component that embodies a profile usable in a ranging device. The profile manager may be a FiRa profile manager.

“Service” may be implementation of a use case that provides a service to an end-user.

“Smart ranging device” may be a ranging device capable of embodying an optional framework API. The smart ranging device may be a FiRa smart device.

“Global dedicated file (GDF)” may be a root level of application specific data including data needed for configuring a USB session.

“Framework API” may be an API used by a UWB-enabled application for communication with a framework.

“Initiator” may be a ranging device that initiates ranging exchange. The initiator may initiate ranging exchange by transmitting a first RFRAME (ranging exchange message).

“Object identifier (OID)” may be an identifier of an ADF in an application data structure.

“Out-of-band (OOB)” may be data communication that is underlying wireless technology and does not use UWB.

“Ranging data set (RDS)” may be data (e.g., UWB session key, session ID, or the like) required for configuring a UWB session in which confidentiality, authenticity, and integrity need to be protected.

“Responder” may be a ranging device that responds to an initiator in ranging exchange. The responder may respond to a ranging exchange message received from the initiator.

“STS” may be a ciphered sequence to increase integrity and accuracy of ranging measurement timestamps. The STS may be generated from a ranging session key.

“Secure channel” may be a data channel that prevents overhearing and tampering.

“Secure component”, for example, may be an entity (e.g., secure element (SE) or a trusted execution environment (TEE)) that has a defined security level and interfaces a UWBS for the purpose of providing an RDS to the UWBS, in the case in which a dynamic STS is used.

“SE” may be a tamper-resistant secure hardware component that may be used as a secure component in a ranging device.

“Secure ranging” may be ranging based on an STS generated via a strong encryption operation.

“Secure service” may be a software component for interfacing a secure component such as a secure element or TEE.

“Service applet” may be an applet in a secure component that manages a service specific transaction.

“Service data” may be data which is defined by a service provider and needs to be transferred between two ranging devices to implement a service.

“Service provider” may be an entity that defines and provides hardware and software required to provide a predetermined service to an end-user.

“Static STS mode” may be an operation mode in which an STS is repeated during a session, and may not need to be managed by a secure component.

“Secure UWB service (SUS) applet” may be an applet in an SE, communicating with an applet, in order to search for data needed to enable a secure UWB session with another ranging device. In addition, the SUS applet may transfer the corresponding data (information) to a UWBS.

“UWB service” may be a software component that provides access to a UWBS.

“UWB session” may be a period of time from a start of communication between a controller and a controlee via a UWB to an end. The UWB session may include ranging, data transferring, or both ranging and data transferring.

“UWB session ID” may be an ID (e.g., 32-bit integer number) that identifies a UWB session, and is shared between a controller and a controlee.

“UWB session key” may be a key used to protect a UWB session. The UWB session key may be used for generating an STS. The UWB session key may be a UWB ranging session key (URSK), and may be referred to as a session key for short.

“UWB subsystem (UWBS)” may be a hardware component that embodies a UWB PHY and MAC layers (spec). The UWBS may have an interface to a framework and an interface to a secure component for searching for an RDS.

“UWB message” may be a message including a payload IE transmitted by a UWB device (e.g., ERDEV). The UWB message, for example, may be a message such as a ranging initiation message (RIM), ranging response message (RRM), ranging final message (RFM), control message (CM), measurement report message (MRM), ranging result report message (RRRM), control update message (CUM), or one-way ranging (OWR). When needed, a plurality of messages may be combined into a single message.

“OWR” may be a ranging scheme that uses messages transmitted in one direction between a ranging device and one or more other ranging devices. The OWR may be used for measuring a time difference of arrival (TDoA). In addition, the OWR may be used for measuring an AoA by a reception side, as opposed to measuring a TDoA. In this instance, a pair of an advertiser and an observer may be used.

“TWR” may be a ranging scheme that measures a time of flight (ToF) by exchanging a ranging message between two devices, and estimates a relative distance between the two devices. The TWR scheme may be one of double-sided two-way ranging (DS-TWR) and single-sided two way ranging (SS-TWR). The SS-TWR may be a procedure that performs ranging by performing round-trip time measurement once. For example, SS-TWR may include an RIM transmission operation from an initiator to a responder and an RRM transmission operation from the responder to the initiator. The DS-TWR may be a procedure that performs ranging by performing round-trip time measurement twice. For example, the DS-TWR may include an RIM transmission operation from an initiator to a responder, an RRM transmission operation from the responder to the initiator, and an RFM transmission operation from the initiator to the responder. Via the ranging exchange (ranging message exchange), a time of flight (ToF) may be calculated, and a distance between two devices may be estimated. In the TWR process, measured AoA information (e.g., AoA azimuth result, AoA elevation result) may be transferred to another ranging device via an RRRM or another message. In the disclosure, the TWR may be referred to as UWB TWR.

“DL-TDoA” may be referred to as a downlink time difference of arrival (DL-TDoA) or reverse TDoA. While a plurality of anchor devices broadcast a message or exchange a message, a user device (tag device) may overhear a message of an anchor device, which is a basic operation. The DL-TDoA may be classified as a type of one way ranging, similar to an uplink TDoA. A user device that performs a DL-TDoA operation may overhear messages transmitted from two anchor devices, and may calculate a time difference of arrival (TDoA) that is proportional to a difference in distances between the user device and the anchor devices. The user device may calculate a relative distance to an anchor device by using TDoAs of many pairs of anchor devices, and may use the same for positioning. An operation of an anchor device for a DL-TDoA may perform an operation similar to double side-two way ranging (DS-TWR) defined in IEEE 802.15.4z, and may further include another useful time information so that a user device is capable of calculating a TDoA. In the disclosure, a DL-TDoA may be referred to as DL-TDoA localization.

“Anchor device” may be referred to as an anchor, a UWB anchor, or a UWB anchor device, and may be a UWB device disposed in a predetermined location in order to provide a positioning service. For example, an anchor device may be a UWB device that a service provider installs in a wall, ceiling, structure or the like in a room in order to provide an indoor positioning service. The anchor device may be classified as an initiator anchor or a responder anchor based on an order of message transmission and a role.

“Initiator anchor” may be referred to as an initiator UWB anchor, an initiator anchor device, or the like, and may indicate initiation of a predetermined ranging round. The initiator anchor may schedule a ranging slot in which responder anchors, operating in the same ranging round, respond. An initiation message of the initiator anchor may be referred to as an initiator downlink TDoA message (initiator DTM) or a poll message. The initiation message of the initiator anchor may include a transmission timestamp. The initiator anchor may additionally transfer a termination message after receiving responses of responder anchors. The termination message of the initiator anchor may be referred to as a final DTM or final message. The termination message may include reply times with respect to messages sent by responder anchors. The termination message may include a transmission timestamp.

“Responder anchor” may be referred to as a responder UWB anchor, a responder UWB anchor device, a responder anchor device, or the like. The responder anchor may be a UWB anchor that responds to an initiation message of an initiator anchor. A message that the responder anchor sends as a response may include a reply time for an initiation message. A message that the responder anchor sends as a response may be referred to as a responder DTM, or a response message. The response message of the responder anchor may include a transmission timestamp.

“Cluster” may be a set of UWB anchors that cover a predetermined area. The cluster may be configured with an initiator UWB anchor and responder UWB anchors that respond thereto. A single initiator UWB anchor and at least three responder UWB anchors are generally needed for 2D positioning, and a single initiator UWB anchor and at least four responder UWB anchors are needed for 3D positioning. If an initiator UWB anchor and a responder UWB anchor are capable of being time-synchronized (time synchronization) accurately via a separate wired/wireless connection, a single initiator UWB anchor and two responder UWB anchors are needed for 2D positioning and a single initiator UWB anchor and three responder UWB anchors are needed for 3D positioning. Unless otherwise mentioned, it is assumed that a separate wired/wireless device for time synchronization between UWB anchors does not exist. A cluster region may be a space for UWB anchors that constitute a cluster. A positioning service may be provided to a user device by configuring a plurality of clusters in order to support a positioning service for a wide area. A cluster may be referred to as a cell. A cluster operation may be understood as an operation of an anchor(s) belonging to a cluster.

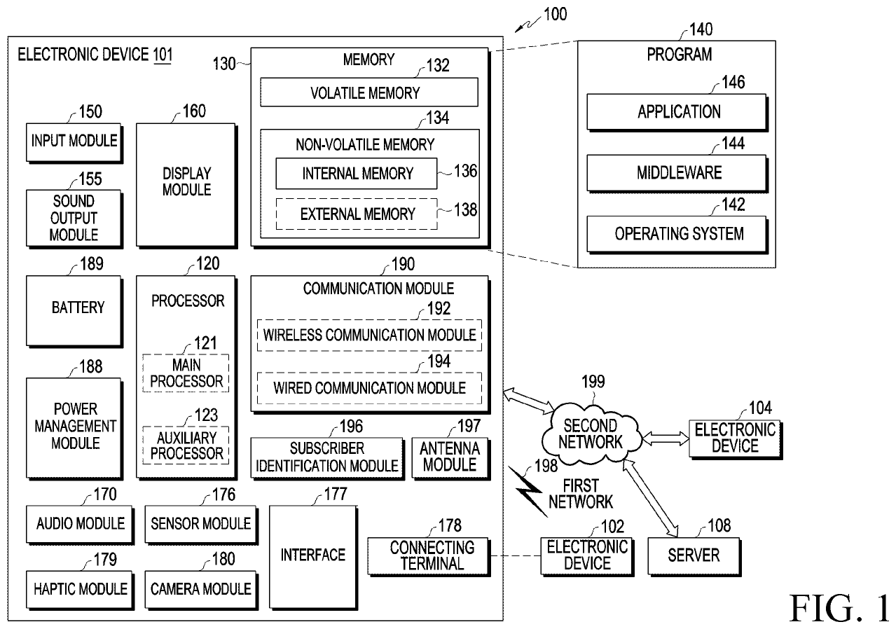

FIG. 1 is a block diagram schematically illustrating an electronic device.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit, a neural processing unit (NPU), an image signal processor, a sensor hub processor, or a communication processor) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control, for example, at least some of functions or states related to at least one component (e.g., the display module 160), the sensor module 176, or the communication module 190) among the components of the electronic device 101, instead of the main processor 121 while the main processor 121 is in an inactive (e.g., sleep) state, or together with the main processor 121 while the main processor 121 is in an active (e.g., executing an application) state. According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial model may be generated through machine learning. Such learning may be performed, e.g., by the electronic device 101 where the artificial intelligence model is performed or via a separate server (e.g., the server 108). A learning algorithm may include, for example, supervised learning, unsupervised learning, semi-supervised learning, or reinforcement learning, but is not limited to the above examples. The artificial intelligence model may include a plurality of artificial neural network layers. The artificial neural network may be one of a deep neural network (DNN), a convolutional neural network (CNN), a recurrent neural network (RNN), a restricted Boltzmann machine (RBM), a deep brief network (DBN), a bidirectional recurrent deep neural network (BRDNN), a deep Q-network, and a combination of two or more thereof, but is not limited to the above examples. Additionally or alternatively, the artificial intelligence model may include a software structure, in addition to the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing back multimedia or records. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170) may convert a sound into an electrical signal and vice versa. According to an embodiment, the audio module 170 may obtain the sound via the input module 150, or output the sound via the sound output module 155 or an external electronic device (e.g., an electronic device 102 (e.g., a speaker or a headphone)) directly or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly or wirelessly. According to an embodiment, the interface 177 may include, for example, a high definition multimedia interface (HDMI), a universal serial bus (USB) interface, a secure digital (SD) card interface, or an audio interface.

The connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be incorporated into a single component (e.g., a single chip), or may be implemented as multi components (e.g., multiple chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support high-speed transmission of high-capacity data (enhanced mobile broadband (eMBB)), terminal power minimization and multi-terminal access (massive machine type communications (mMTC)), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed at a first surface (e.g., the lower surface) of the printed circuit board or adjacent thereto and capable of supporting specified high-frequency bands (e.g., mmWave bands), and a plurality of antennas (e.g., an array antenna) disposed at a second surface (e.g., the upper or side surface) of the printed circuit board or adjacent thereto and capable of transmitting or receiving signals in the specified high-frequency bands.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To this end, a cloud computing, distributed computing, mobile edge computing (MEC), or client-server computing technology may be used, for example. The electronic device 101 may provide ultralow-latency services using, for example, distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments set forth herein may be one of various types of electronic devices. The electronic device may include, for example, a portable communication device (e.g., a smart phone), a computer device, a portable multimedia device, a portable medical device, a camera, a wearable device, or a home appliance. The electronic device according to embodiments of the disclosure is not limited to those described above.

It should be appreciated that various embodiments of the disclosure and the terms used therein are not intended to limit the technological features set forth herein to particular embodiments and the disclosure includes various changes, equivalents, or alternatives for a corresponding embodiment. With regard to the description of the drawings, similar reference numerals may be used to designate similar or relevant elements. A singular form of a noun corresponding to an item may include one or more of the items, unless the relevant context clearly indicates otherwise. As used herein, each of such phrases as “A or B.” “at least one of A and B.” “at least one of A or B,” “A, B, or C.” “at least one of A, B, and C,” and “at least one of A, B, or C.” may include any one or all possible combinations of the items enumerated together in a corresponding one of the phrases. Such terms as “a first,” “a second,” “the first,” and “the second” may be used to simply distinguish a corresponding element from another, and does not limit the elements in other aspect (e.g., importance or order). If an element (e.g., a first element) is referred to, with or without the term “operatively” or “communicatively”, as “coupled with/to” or “connected with/to” another element (e.g., a second element), it means that the element may be coupled/connected with/to the other element directly (e.g., wiredly), wirelessly, or via a third element.

As used in various embodiments of the disclosure, the term “module” may include a unit implemented in hardware, software, or firmware, and may be interchangeably used with other terms, for example, “logic.” “logic block,” “component,” or “circuit”. The “module” may be a single integrated component, or a minimum unit or part thereof, adapted to perform one or more functions. For example, according to an embodiment, the “module” may be implemented in the form of an application-specific integrated circuit (ASIC).

Various embodiments as set forth herein may be implemented as software (e.g., the program 140) including one or more instructions that are stored in a storage medium (e.g., the internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions each may include a code generated by a complier or a code executable by an interpreter. The machine-readable storage medium may be provided in the form of a non-transitory storage medium. Herein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, methods according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each element (e.g., a module or a program) of the above-described elements may include a single entity or multiple entities, and some of the multiple entities may also be separately disposed in another element. According to various embodiments, one or more of the above-described elements or operations may be omitted, or one or more other elements or operations may be added. Alternatively or additionally, a plurality of elements (e.g., modules or programs) may be integrated into a single element. In such a case, according to various embodiments, the integrated element may still perform one or more functions of each of the plurality of elements in the same or similar manner as they are performed by a corresponding one of the plurality of elements before the integration. According to various embodiments, operations performed by the module, the program, or another element may be carried out sequentially, in parallel, repeatedly, or heuristically, or one or more of the operations may be executed in a different order or omitted, or one or more other operations may be added.

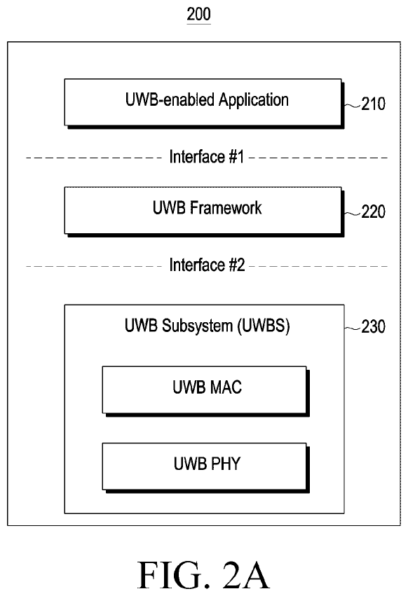

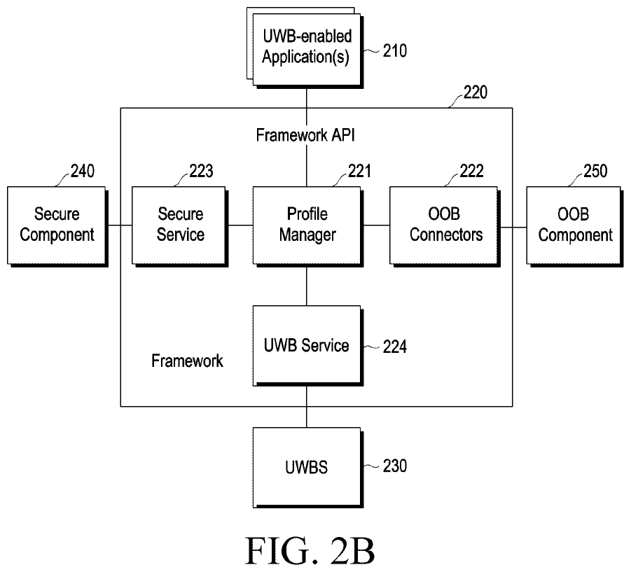

FIG. 2A is a diagram illustrating an architecture of a UWB device according to an embodiment of the disclosure.

In the disclosure, a UWB device 200 may be an electronic device that supports UWB communication. For example, the UWB device 200 may an example of the electronic device 101 of FIG. 1.

The UWB device 200, for example, may be a ranging device that supports UWB ranging. According to an embodiment, the ranging device may be an enhanced ranging device (ERDEV) or FiRa device.

In the embodiment of FIG. 2A, the UWB device 200 may interact with another UWB device via a UWB session.

In addition, the UWB device 200 may embody a first interface (interface #1) that is an interface between a UWB-enabled application 210 and a UWB framework 220, and the first interface may enable the UWB-enabled application 110 in the UWB device 200 to use UWB capabilities of the UWB device 200 in a predetermined manner. According to an embodiment, the first interface may be a framework API or proprietary interface, but it is not limited thereto.

In addition, the UWB device 200 may embody a second interface (interface #2) that is an interface between the UWB framework 210 and a UWB subsystem (UWBS) 230. According to an embodiment, the second interface may be a UWB command interface (UCI) or proprietary interface, but it is not limited thereto.

With reference to FIG. 2A, the UWB device 200 may include the UWB-enabled application 210, the framework (UWB framework) 220, and/or the UWBS 230 including a UWB MAC layer and a UWB physical layer. In some embodiments, some entities may not be included in the UWB device or an additional entity (e.g., security layer) may be further included.

The UWB-enabled application 210 may trigger configuration of a UWB session by the UWBS 230 by using the first interface. In addition, the UWB-enabled application 210 may use one of predefined profiles. For example, the UWB-enabled application 210 may use one of the profiles defined in FiRa or may use a custom profile. The UWB-enabled application 210 may manage a related event, such as service discovery, ranging notifications, and/or error conditions, by using the first interface.

The framework 220 may enable access to a profile, and provide an individual UWB configuration and/or notification. In addition, the framework 220 may support at least one of a function of performing UWB ranging and transaction, a function of providing an interface to the UWBS 230 and an application, or a function of estimating a position of the device 200. The framework 220 may be a set of software components. As described above, the UWB-enabled application 210) may interface with the framework 220) via the first interface, and the framework 220 may interface with the UWBS 230) via the second interface.

In the disclosure, the UWB-enabled application 210 and/or the framework 220 may be embodied by an application processor (AP) (or processor). Therefore, in the disclosure, it may be understood that operation of the UWB-enabled application 210 and/or the framework 220 is performed by an AP (or processor). In the disclosure, the framework may be referred to as an AP or a processor.

The UWBS 230 may be a hardware component including a UWB MAC layer and a UWB physical layer. The UWBS 230 may perform UWB session management, and may communicate with a UWBS of another UWB device. The UWBS 230 may interface with the framework 120 via the second interface, and may obtain secure data from a secure component. In an embodiment, the framework 220 (or application processor) may transmit a command to the UWBS 230 via a UCI, and the UWBS 230 may transfer a response to the command to the framework 220. The UWBS 230 may transfer a notification to the framework 120 via a UCI.

FIG. 2B is a diagram illustrating a configuration of a framework of a UWB device according to an embodiment of the disclosure.

The UWB device of FIG. 2B may be an example of the UWB device of FIG. 2A.

Referring to FIG. 2B, the framework 220, for example, may include software components such as a profile manager 221, an OOB connector(s) 222, a secure service 223, and/or a UWB service 224.

The profile manager 221 may perform a role for managing a profile usable in the UWB device. Here, the profile may be a set of parameters required for configuring communication between UWB devices. For example, the profile may include a parameter indicating an OOB secure channel used, a UWB/OOB configuration parameter, a parameter indicating whether use of a predetermined secure component is mandatory, and/or a parameter related to a file structure of an ADF. The UWB-enabled application 210 may communicate with the profile manager 221 via a first interface (e.g., framework API).

The OOB connector 222 may perform a role for configuring an OOB connection with another device. The OOB connector 222 may manage an OOB operation including a discovery operation and/or a connection operation. The OOB component (e.g., BLE component) 250) may be connected to the OOB connector 222.

The secure service 223 may perform a role of interfacing with the secure component 240 such as an SE or TEE.

The UWB service 224 may perform a role of managing the UWBS 230. The UWB service 224 may embody a second interface, and may provide access from the profile manager 321 to the UWBS 230.

The disclosure provides a method and apparatus for performing pose detection by using a UWB signal. The UWB signal may be a UWB signal used for DL-TDoA ranging (OWR), or may be a UWB signal used for DS-TWR ranging. In the disclosure, a pose, for example, may be related to by what a user carries a user device (e.g., handheld) or where a user keeps a user device (e.g., back pocket/front pocket).

The disclosure provides a method of receiving a UWB signal, obtaining UWB channel impulse response (CIR) data, and classifying whether the UWB signal is a line of sight (LOS) signal or a non-LOS (NLOS) signal based on the UWB CIR data. For LOS signal or NLOS signal classification, a convolutional neural network (CNN) algorithm may be used. As described above, by classifying data having a time series characteristic by using a CNN model, high classification accuracy may be provided. As input data for a CNN model used for classifying an LOS signal or an NLOS signal, effective CIR data from which noise is removed from the UWB CIR data may be used. Through the above, accuracy of LOS/NLOS signal classification and accuracy of pose classification may be increased.

The disclosure may provide a scheme of classifying a pose by using an LOS signal or NLOS signal classification result (signal classification result) and sensing data. As the sensing data, data of an inertial measurement unit (IMU) sensor may be used. To perform pose classification using the signal classification result and sensing data, two CNN models (e.g., 2 CNN models in a parallel structure) may be used, which are different from the CNN model used for LOS/NLOS signal classification. One of the two CNN models may be trained using IMU data (first training data) associated with an LOS signal and the other CNN model may be trained using IMU data (second training data) associated with an NLOS signal. By classifying data having different characteristics by using separate CNN models, classification accuracy may be increased.

The disclosure provides a method of filtering predicted data output from each CNN model, before performing final LOS/NLOS signal classification and final pose classification. For filtering, a moving average filter may be used. Through the above, accuracy of LOS/NLOS signal classification and accuracy of pose classification may be increased.

The disclosure provides a method of using a classified LOS/NLOS signal and/or classified pose by various applications of a user device. For example, an application for a tagless gate, a digital car key application, or a point of service (POS) application may use the classification method of the disclosure. The application may appropriately provide a predetermined service or a function/parameter associated with a predetermined service by using an accurately classified LOS/NLOS signal and/or classified pose.

According to an embodiment, by using an accurately classified LOS/NLOS signal, the application may adjust an adaptive ranging frequency which is for power saving. For example, the application may configure a maximizing sleep duration by adjusting an adaptive ranging frequency by using a classified LOS/NLOS signal.

According to an embodiment, the application may selectively use only an LOS signal via accurate LOS/NLOS signal classification, thereby increasing accuracy of position estimation.

According to an embodiment, the application may configure an adaptive access boundary via accurate LOS/NLOS signal and pose classification. For example, when the situation of an NLOS signal/back pocket pose is identified, the application may delay the start of a service.

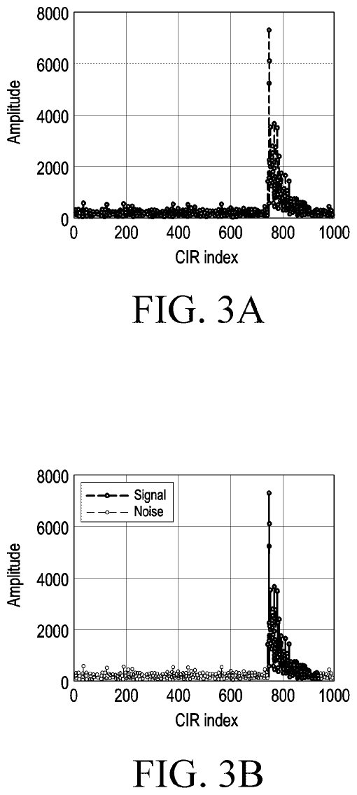

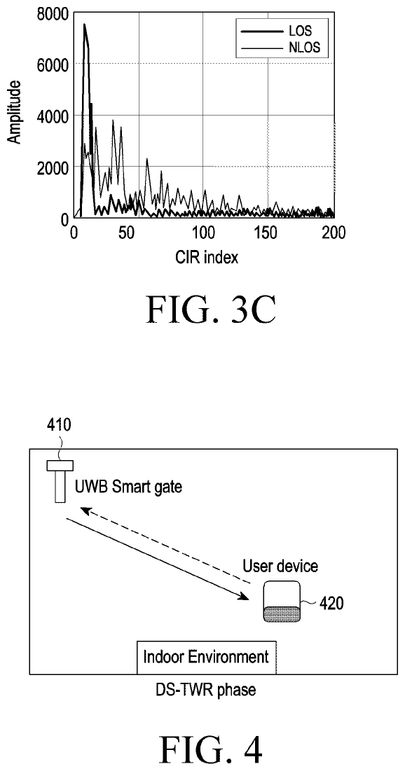

FIG. 3A is a diagram illustrating an example of UWB CIR data according to an embodiment of the disclosure.

A UWB channel impulse response (CIR) may be obtained by receiving a UWB signal. For example, when an electronic device receives a UWB signal for DL-TDoA or a UWB signal for DS-TWR, the electronic device may obtain UWB CIR data based on the received signal. In the disclosure, the UWB CIR may be referred to as CIR for short.

According to an embodiment, the electronic device may obtain UWB CIR data by using a correlation value between an impulse function and a received UWB signal.

An example of UWB CIR data obtained based on a UWB signal may be as shown in FIG. 3A. As illustrated in FIG. 3A, for example, 1016 CIR values may be output. Each CIR value, for example, may be a value measured or obtained based on each UWB signal including a final message (RIM) that a responder receives from an initiator a DS-TWR process. Alternatively, each CIR value, for example, may be a value measured or obtained based on each UWB signal including a final message that a user device (tag device) receives from an initiator anchor in a DL-TDoA process.

Referring to FIG. 3A, a peak of an amplitude may occur after a predetermined CIR index (e.g., CIR index 750)).

FIG. 3B is a diagram illustrating an example of effective UWB CIR data according to an embodiment of the disclosure.

In the disclosure, an effective UWB CIR may be a CIR having a significant value among CIRs. That is, the effective UWB CIR may be a CIR measured or obtained by an actual signal, as opposed to noise. In the disclosure, the effective UWB CIR may be referred to as an effective CIR (eCIR).

According to an embodiment, the electronic device may process, as noise, CIR values before a peak occurs, and may process, as eCIRs, n CIR values from the peak.

According to an embodiment, the electronic device may determine, as eCIRs, n CIRs from a CIR index obtained by subtracting a margin value from a CIR index at which a peak occurs. For example, in the case in which a peak occurs at CIR index 750) and a margin value is 5 (margin=5), and n value is configured to 200 (n=200), the electronic device may identify CIRs from the CIR index 745 to CIR index 945 as eCRIs. As described above, CIRs may be classified as signals and noise, and an example of the classification may be as shown in FIG. 3B.

In the case in which CIRs classified as eCIRs among obtained CIRs are only used as input data for a CNN model for LOS/NLOS signal classification, inaccurate noise may be removed and accuracy of classification may be increased.

In addition, in the case in which CIRs classified as eCIRs among obtained CIRs are used, latency for CIR data exchange may be optimized.

In addition, in the case in which CIRs classified as eCIRs among obtained CIRs are used, an input matrix may be optimized and a terminal's processing efficiency may be improved.

FIG. 3C is a diagram illustrating an example of an LOS signal and an NLOS signal classified using UWB CIR data according to an embodiment of the disclosure.

As described above, CIR values used for LOS signal/NLOS signal classification may be eCIR values. For example, as illustrated in FIG. 3C, n (e.g., 200) eCIR values may be used for LOS/NLOS signal classification.

CIR values (eCIR values) of an LOS signal and an NLOS signal may have different characteristics.

For example, an LOS signal may have at least one of the following characteristics.
A peak value of a CIR is higher than a peak value of an NLOS signal.
A CIR value after a peak is dramatically decreased to a noise level.
A small number of peaks occur, for example, one or two peaks.

For example, an NLOS signal may have at least one of the following characteristics.
A peak value of a CIR is lower than a peak value of an LOS signal.
It takes long period of time until a CIR value after a peak is decreased to a noise level.
Multiple peaks appear due to a multipath signal.

Due to the difference in characteristics of CIR values between an LOS signal and an NLOS signal, whether a corresponding signal is an LOS signal or an NLOS signal may be classified based on measured CIR data.

According to an embodiment, the electronic device may use a deep learning algorithm in order to classify whether a corresponding signal is an LOS signal or an NLOS signal by using CIR data (eCIR data) for the corresponding signal. For example, the electronic device may classify an LOS/NLOS signal by using a CNN model (CNN algorithm). A LOS/NLOS signal classification method using a CNN model will be described with reference to FIGS. 4 to 11.

Hereinafter, for ease of description, it is assumed that four cases for generating data used for LOS/NLOS signal classification and/or pose classification are classified as below.

(1) Hand LOS case (handheld (LOS) pose): a case in which a user holds an electronic device in a hand (handheld), and does not cover a UWB antenna of the electronic device.

(2) Hand NLOS case (handheld (NLOS) pose) a case in which a user holds an electronic device in a hand (handheld), and covers a UWB antenna of the electronic device.

(3) Front pockek (LOS) case (front pockek (LOS) pose): a case in which an electronic device is in a front pocket of a user and an LOS signal is secured.

(4) Back pocket (NLOS) case (back pocket (NLOS) pose): a case in which an electronic device is in a back pocket of a user and a signal is blocked by a body effect.

In a predetermined environment (e.g., an environment in which a user's electronic device approaches (is getting close to) an initiator for UWB ranging (e.g., an initiator for DS-TWR or an initiator anchor for DL-TDoA (OWR)), data for the four cases mentioned above (e.g., UWB CIR data and/or IMU sensor data) may be collected. The collected data may be used for training and testing each CNN model. In this instance, the embodiment is not limited thereto, and data of another environment and/or another case may be collected and used for training/testing a CNN model according to an embodiment.

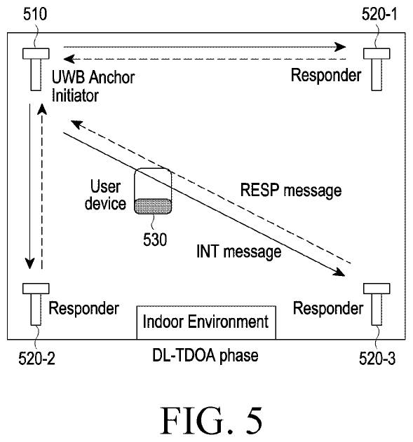

With reference to FIGS. 4 and 5, examples of an environment to which LOS/NLOS classification is applicable, for example, DS-TWR of FIG. 4 and DL-TDoA of FIG. 5, will be described.

FIG. 4 is a diagram illustrating DS-TWR according to an embodiment of the disclosure.

Referring to FIG. 4, DS-TWR may be performed between a first electronic device 410 and a second electronic device 420.

In the embodiment of FIG. 4, for ease of description, it is assumed that the first electronic device 410) performs a role of an initiator for DS-TWR, and the second electronic device 420, which is a user's electronic device, performs a role of a responder for DS-TWR. In this instance, it is assumed that the second electronic device 420) approaches the first electronic device 410 that is an initiator. In this instance, the embodiment is not limited thereto, and for example, a reverse case may also be applicable.

According to an embodiment, the first electronic device 410, for example, may be a UWB-based gate (UWB smart gate), and the second electronic device 420 may be a user's electronic device (e.g., a user's smartphone).

Referring to FIG. 4, in one ranging cycle (one ranging measurement cycle), the first electronic device 410 that is an initiator may initiate a DS-TWR ranging procedure by transmitting a ranging initiation message (RIM), and the second electronic device 420) that is a responder may transmit, to the first electronic device 410, a ranging response message (RRM) that is a response message to the RIM, and the first electronic device 410 may transmit, to the second electronic device 420, a ranging final message (RFM) that is a response message to the RRM. The one ranging measurement cycle for DS-TWR may be repeatedly (e.g., periodically) performed.

According to an embodiment, the second electronic device 420 may obtain a CIR value for each UWB signal including a received RFM. CIR data obtained in this manner may be used for LOS/NLOS signal classification.

According to an embodiment, the second electronic device 420 may obtain sensing data of an IMU sensor together with CIR data. According to an embodiment, a cycle for obtaining IMU sensor data may be different from (e.g., shorter than) a cycle for obtaining CIR data. In this instance, in order to input IMU sensor data corresponding to the CIR data as an input of a CNN model, a sequencing operation needs to be performed.

FIG. 5 is a diagram illustrating a DL-TDoA according to an embodiment of the disclosure.

According to an embodiment of FIG. 5, for ease of description, it is assumed that a single initiator anchor (initiator UWB anchor) 510 and three responder anchors (responder UWB anchors) 520-1, 520-2, and 520-3 are used for a DL-TDoA. In this instance, it is assumed that an electronic device 530 approaches the initiator anchor 510) that is an initiator. In this instance, the embodiment is not limited thereto, and for example, a different number of anchor devices may also be applicable.

Referring to FIG. 5, in one ranging cycle (one ranging measurement cycle), the initiator anchor 510 that is an initiator may initiate a DL-TDoA ranging procedure by transmitting an initiation message, and each of the responder anchors 520-1, 520-2, and 520-3 that are responders may transmit, to the initiator anchor 510, a response message to the initiation message, and the initiator anchor 510 may transmit, to each responder anchor 520-1, 520-2, and 520-3, a final message that is a response message to the response message. The user device 530 may receive the initiation message, the response messages, and the final messages, and may estimate its position according to a previously defined method.

According to an embodiment, the user device 530) may obtain a CIR value for each UWB signal including a received final message. CIR data obtained in this manner may be used for LOS/NLOS signal classification.

According to an embodiment, the user device 530 may obtain sensing data of an IMU sensor together with CIR data. According to an embodiment, a cycle for obtaining IMU sensor data may be different from (e.g., shorter than) a cycle for obtaining CIR data. In this instance, in order to input IMU sensor data corresponding to the CIR data as an input of a CNN model, a sequencing operation needs to be performed.

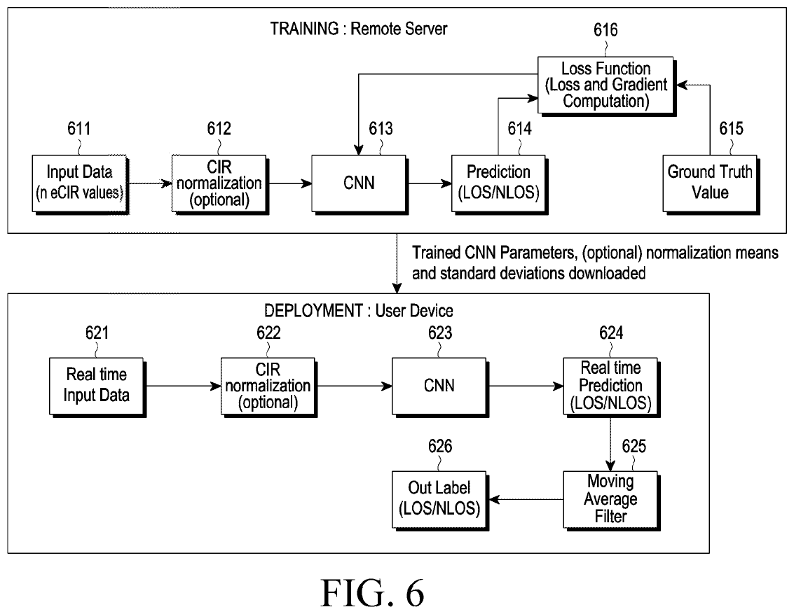

FIG. 6 is a diagram illustrating a training procedure and a deployment procedure for LOS/NLOS signal classification using UWB channel impulse response data according to an embodiment of the disclosure.

In the embodiment of FIG. 6, for ease of description, it is assumed that a training procedure 610 is performed in a remote server, and a deployment procedure 620 is performed in a user device. In this instance, the embodiment is not limited thereto. For example, if the user device is a device having high computing power, a training procedure may also be performed in the user device.

With reference to FIG. 6, the training procedure 610 will be described.

In the training procedure 610, a server may collect input data in operation 611. For example, the server may collect CIR data (e.g., eCIR data including n eCIR values) as input data for training.

The server may perform CIR normalization processing with respect to the collected input data in operation 612. For example, the server may normalize the collected input data to a range of 0 to 1. In this instance, the CIR normalization of operation 612 is an optional operation and may be omitted.

The server may input CIR normalized data or CIR non-normalized data as input data of a CNN model, and may perform processing for LOS/NLOS classification using the CNN model in operation 613.

Tables 1 and 2 given below show examples of hyperparameters and characteristics of a CNN model used for LOS/NLOS classification.

TABLE 1

| | NUMBER OF | FILTER | ACTIVATION |
|---|---|---|---|
| LAYER | FILTERS | SIZE | FUNCTION |
| Conv1D | 64 | 5 | — |
| Instance Normalization | — | — | ReLU |
| MaxPool1D | — | 2 | — |
| Conv1D | 128 | 11 | — |
| Instance Normalization | — | — | ReLU |
| MaxPool1D | — | 2 | — |
| Conv1D | 256 | 17 | — |
| Instance Normalization | — | — | ReLU |
| MaxPool1D | — | 2 | — |
| Conv1D | 512 | 5 | — |
| Instance Normalization | — | — | ReLU |
| MaxPool1D | — | 2 | — |
| Flatten | — | — | — |
| Dense | — | — | sigmoid |

TABLE 2

| | |
|---|---|
| Weights Initializer | Random |
| Solver | Adam |
| Maximum number of Training Epochs | 100 |
| Batch Size | 50 |
| Shuffle | Every Epoch |
| Dropout | 0.2 |
| Loss Function | Binary Cross-entropy |

The server may obtain a predicted value output from the CNN model in operation 614. According to an embodiment, the predicted value may include a predicted probability value for a label (e.g., label 1) corresponding to an LOS signal and a predicted probability value for a label (e.g., label 2) corresponding to an NLOS signal.

The server may obtain a ground truth value for a corresponding signal in operation 615. According to an embodiment, the ground truth value may include a ground truth probability value for a label (e.g., label 1) corresponding to an LOS signal and/or a ground truth probability value for a label (e.g., label 2) corresponding to an NLOS signal.

The server may calculate a loss between the predicted value of operation 614 and the ground truth value of operation 615 and a gradient value by using a loss function, in operation 616. For example, a total loss may be calculated based on a loss between the predicted value and the ground truth value associated with the LOS signal and a loss between the predicted value and the ground truth value associated with the NLOS signal.

The server may update parameters of the CNN model by using the value obtained in operation 616. For example, by using a back-propagation scheme, the server may update the parameters of the CNN model to decrease a loss. The parameters updated as described above may be used for the CNN model in order to process subsequent input data (e.g., subsequent n eCIR values).

By performing the above-described training procedure 610 with respect to all of the collected input data sets (e.g., each input data set includes n eCIR values), the server may continuously update the parameters of the CNN model (CNN parameters) to decrease a loss. The user device may obtain or download the CNN parameters trained in this manner. In addition, the user device may download information associated with whether normalization is used. In addition, the user device may download standard deviations related to the CNN model.

Hereinafter, with reference to FIG. 6, the deployment procedure 620 will be described.

In the deployment procedure 620, the user device may collect real time input data in operation 621. For example, the user device may collect a plurality of CIR values (e.g., eCIR values) as input data, and may divide the same based on a predetermined number of lengths (sizes) (e.g., n lengths) and process the same. According to an embodiment, the length (n) may be the same as a length (n) used for training.

The user device may perform CIR normalization with respect to the collected input data in operation 622. For example, the user device may normalize the collected input data to a range of 0 to 1. In this instance, the CIR normalization of operation 622 is an optional operation and may be omitted.

The user device may input CIR normalized data or CIR non-normalized data as input data of the CNN model, and may perform processing for LOS/NLOS classification using a CNN model in operation 623. The CNN model of the user device may use the CNN parameters obtained by the training procedure 610 in order to process the input data.

The user device may obtain predicted data (real time predicted data) output from the CNN model in operation 624. According to an embodiment, the predicted data output from the CNN model may include a predicted value (first predicted value) for first eCIR data (first n eCIR data among the real time input data), a predicted value (second predicted value) for second eCIR data (second n eCIR data among the real time input data), . . . and a predicted value (n^{th} predicted value) for n^{th} eCIR data (n^{th} n eCIR data among the real time input data). According to an embodiment, each predicted value may include a predicted probability value for a label (e.g., label 1) corresponding to an LOS signal and/or a predicted probability value for a label (e.g., label 2) corresponding to an NLOS signal, in association with corresponding eCIR data.

The user device may perform filtering of a predicted value (predicted data) by using a filter (e.g., low pass filter (LPF) or moving average filter) in operation 625. According to an embodiment, a moving average filter may have a window lengeth parameter indicating a length of a window used for calculating an average of data, as a hyperparameter, and the user device may perform filtering of predicted data by using the moving average filter having the window lengeth parameter. For example, the user device may replace each predicted value with an average value that is associated with the corresponding predicted value and is obtained based on the window lengeth parameter, by using the moving average filter.

The user device may obtain an output label for real time input data by using the filtered data in operation 626. By using the filtered data, the user device may finally determine whether an output label for a signal corresponding to the real time input data is a label (e.g., label 1) corresponding to an LOS signal or a label (e.g., label 2) corresponding to an NLOS signal. Through the above, the user device may finally classify whether the corresponding signal is an LOS signal or an NLOS signal. As described above, before final LOS/NLOS signal classification, by providing filtering that uses a moving average filter for predicted data output from the CNN model, accuracy of LOS/NLOS signal classification may be increased.

Table 3 given below shows comparison in accuracy of LOS/NLOS classification between the case with an LPF filter (e.g., moving average filter) and the case without an LPF filter.

TABLE 3

| | Hand | Front pocket | Hand | Back pocket |
|---|---|---|---|---|
| | (LOS) | (LOS) | (NLOS) | (NLOS) |
| w/o LPF | 87.4% | 78.8% | 99.8% | 75.4% |
| w/LPF | 99.4% | 92.0% | 100% | 90.6% |

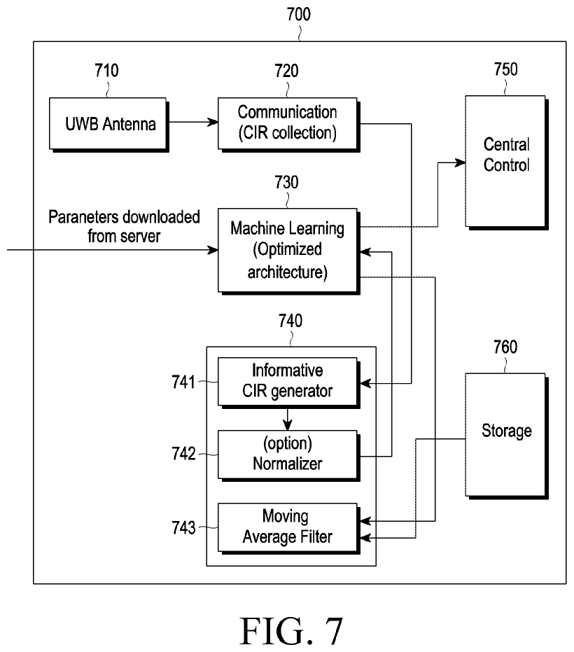

FIG. 7 is a diagram illustrating a configuration of a user device for LOS/NLOS classification according to an embodiment of the disclosure.

Referring to FIG. 7, a user device 700 may include a UWB antenna 710, a CIR collector 720, a machine learning unit 30, a classification processor 740, a central controller 750, and/or a storage 750. The classification processor 740 may include an effect CIR generator 741, a normalizer 742, and/or a moving average filter 743.

According to an embodiment, some of the above-described components may be omitted or an additional component may be further included. According to an embodiment, two or more components among the above-described components may be combined into a single component. According to an embodiment, the whole or part of the above-described components may be embodied by at least one processor (or controller). For example, components excluding the UWB antenna 710 and the storage 750 may be embodied by at least one processor (or controller).

The UWB antenna 710) may receive at least one UWB signal from another electronic device. For example, the UWB antenna 710 may receive at least one UWB signal for DS-TWR or at least one UWB signal for DL-TDoA.

The CIR collector 720 may collect CIR data from at least one UWB signal received via the UWB antenna 710. The CIR collector 720 may transfer the collected CIR data to the effective CIR generator 741. The collected CIR data may include a plurality of CIR values.

The effective CIR generator 741 may generate effective CIR data from the collected CIR data. The effective CIR generator 741 may transfer the generated effective CIR data to the normalizer 742, or may directly transfer the same to the machine learning unit 730). The effective CIR data may include a plurality of effective CIR values, and may be processed by the machine learning unit 730 in units of a predetermined number of values (e.g., in units of n values).

The normalizer 742 may normalize values of the effective CIR (eCIR) data. For example, the normalizer 742 may normalize the values of the effective CIR data to values in the range of 0 to 1. The normalizer 742 may be an optional configuration. For example, the normalizer 742 may not be included in the user device 700, or processing by the normalizer 742 may be omitted although the normalizer 742 is included in the user device 700.

The machine learning unit 730 may generate predicted data using input effective CIR data. According to an embodiment, the machine learning unit 730 may generate predicted data using a CNN model. According to an embodiment, the CNN parameters of the CNN model may be downloaded from a server in which a training procedure is performed in advance. Therefore, the machine learning unit 730) may use an optimized CNN model.

According to an embodiment, the machine learning unit 730 may perform processing in units of a predetermined number of eCIRs (e.g., neCIRs) (eCIR set), and may output a predicted value for each corresponding eCIR set. For example, predicted data may include a predicted value (first predicted value) for first neCIRs (first eCIR set), a predicted value (second predicted value) for subsequent n eCIRs (second eCIR set), . . . and a predicted value (n^{th} predicted value) for n^{th} n eCIRs (n^{th} eCIR set). Each predicted value may include a predicted probability value corresponding to an LOS and a predicted probability value corresponding to an NLOS, with respect to the corresponding eCIR set.

The machine learning unit 730 may transfer the predicted data to the central controller 750 and/or the moving average filter 743.

The central controller 750 may transfer the received predicted data to the storage 730. The storage 730 may store the received predicted data, and may transfer the stored predicted data to the moving average filter 743.

By using the predicted data (e.g., current predicted data) received from the machine learning unit 730) and the predicted data (e.g., previous predicted data) received from the storage 760, the moving average filter 743 may calculate an average value based on a predetermined window length parameter, and may perform filtering of the predicted data using the average value. The filtered predicted data may be used for final LOS signal or NLOS signal classification. The filtered predicted data may be used by various applications.

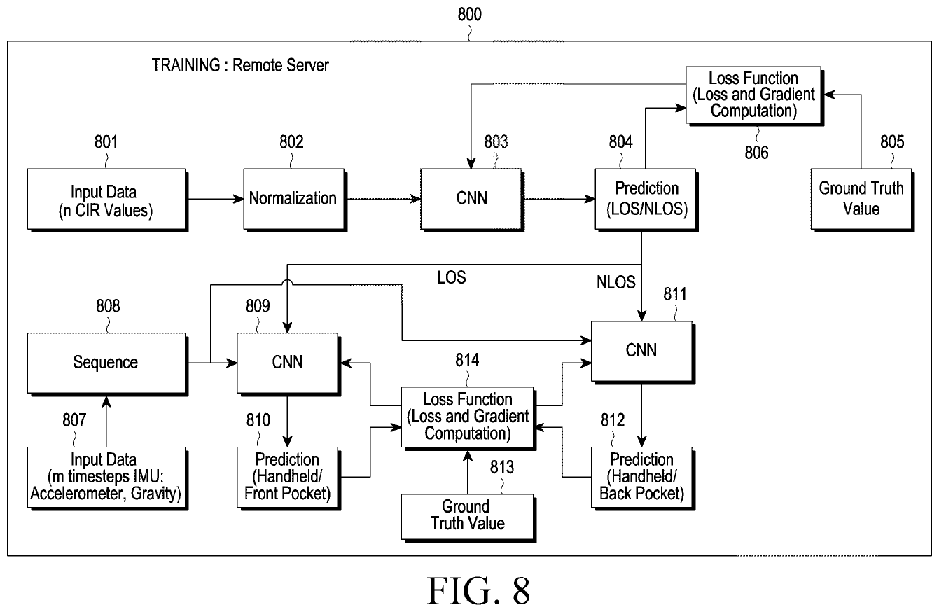

FIG. 8 is a diagram illustrating a training procedure for pose classification based on LOS/NLOS signal classification using UWB channel impulse response data according to an embodiment of the disclosure.

In the embodiment of FIG. 8, for ease of description, it is assumed that a training procedure 810 is performed in a remote server.

With reference to FIG. 8, the training procedure 800 will be described.

In the training procedure 800, a server may collect input data in operation 801. For example, the server may collect CIR data (e.g., eCIR data including n eCIR values) as input data for training.

The server may perform CIR normalization processing with respect to the collected input data in operation 802. For example, the server may normalize the collected input data to a range of 0 to 1. In this instance, the CIR normalization of operation 802 is an optional operation and may be omitted.

The server may input CIR normalized data or CIR non-normalized data as input data of a first CNN model, and may perform processing for LOS/NLOS classification using the first CNN model in operation 803. In the disclosure, the first CNN model is referred to as a CNN model used for LOS/NLOS classification.

The server may obtain a predicted value (first predicted value or first predicted information) output from the first CNN model in operation 804. According to an embodiment, the first predicted value may include a predicted probability value for a label (e.g., label a) corresponding to an LOS signal and a predicted probability value for a label (e.g., label b) corresponding to an NLOS signal.

The server may obtain a ground truth value (first ground truth value or first ground truth information) for a corresponding signal in operation 805. According to an embodiment, the first ground truth value may include a ground truth probability value for a label (e.g., label 1) corresponding to an LOS signal and a ground truth probability value for a label (e.g., label 2) corresponding to an NLOS signal.

The server may calculate a loss between the predicted value of operation 804 and the ground truth value of operation 805 and a gradient value by using a loss function, in operation 806. For example, a total loss may be calculated based on a loss between the predicted value and the ground truth value associated with the LOS signal and a loss between the predicted value and the ground truth value associated with the NLOS signal.

The server may update parameters of the first CNN model by using the value obtained in operation 806. For example, by using a back-propagation scheme, the server may update the parameters of the first CNN model so as to decrease a loss. The parameters updated as described above may be used for the first CNN model in order to process subsequent input data (e.g., subsequent n eCIR values).

By performing the above-described training procedure 800 with respect to all of the collected eCIR sets (e.g., each eCIR set includes n eCIR values), the server may continuously update parameters of the first CNN model (CNN parameters) to decrease a loss. A user device may obtain or download the trained CNN parameters of the first CNN model. In addition, the user device may download information associated with whether normalization is used. In addition, the user device may download standard deviations related to the first CNN model.

Based on a predicted value for a corresponding eCIR set, the server may determine a signal corresponding to the corresponding eCIR set is classified as an LOS signal or an NLOS signal. For example, in the predicted value for the corresponding eCIR set, if a predicted probability value corresponding to an LOS signal is greater than a predicted probability value corresponding to an NLOS signal, the server may determine that the signal corresponding to the corresponding eCIR set is classified as an LOS signal. As another example, in the predicted value for the corresponding eCIR set, if a predicted probability value corresponding to an NLOS signal is greater than a predicted probability value corresponding to an LOS signal, the server may determine that the signal corresponding to the corresponding eCIR set is classified as an NLOS signal.

In the case in which the signal corresponding to the corresponding eCIR set is classified as an LOS signal, a classification procedure associated with pose detection based on a second CNN model may be performed. Alternatively, in the case in which the signal corresponding to the corresponding eCIR set is classified as an NLOS signal, a classification procedure associated with pose detection based on a third CNN model may be performed. In the disclosure, the second CNN model is referred to as a CNN model used for pose classification, which is trained using IMU sensor data associated with an LOS signal. In the disclosure, the third CNN model is referred to as a CNN model used for pose classification, which is trained using IMU sensor data associated with an NLOS signal.

Tables 4 and 5 given below show examples of hyperparameters and characteristics of a CNN model (second CNN model/third CNN model) used for pose classification.

TABLE 4

| | NUMBER OF | FILTER | ACTIVATION |
|---|---|---|---|
| LAYER | FILTERS | SIZE | FUNCTION |
| Conv1D | 64 | 2 | — |
| Instance Normalization | — | — | ReLU |
| MaxPool1D | — | 2 | — |
| Conv1D | 128 | 2 | — |
| Instance Normalization | — | — | ReLU |
| MaxPool1D | — | 2 | — |
| Conv1D | 256 | 2 | — |
| Instance Normalization | — | — | ReLU |
| MaxPool1D | — | 2 | — |
| Flatten | — | — | — |
| Dense | — | — | sigmoid |

TABLE 5

| | |
|---|---|
| Weights Initializer | Random |
| Solver | Adam |
| Maximum number of Training Epochs | 100 |
| Batch Size | 10 |
| Shuffle | Every Epoch |
| Dropout | 0.2 |
| Loss Function | Binary Cross-entropy |

The server may collect sensor input data in operation 807. The sensor input data may be sensor input data (first sensor input data) associated with an LOS signal or sensor input data associated with an NLOS signal (second sensor input data). For example, sensor data, collected in the above-described environment in the state in which a UWB antenna is not covered or is carried in a front pocket, may be sensor input data (first sensor input data) associated with an LOS signal, and sensor data, collected in the above-described environment in the state in which a UWB antenna is covered or is carried in a back pocket, may be sensor input data (second sensor input data) associated with an NLOS.

According to an embodiment, the sensor input data may include IMU values associated with m timesteps (m time series IMU values).

The server may perform sequencing processing in order to input, to the second CNN model or third CNN model, sensor input data corresponding to input data of the first CNN model in operation 808. For example, the server may perform sequencing processing in order to input, to the second CNN model or third CNN model, sensor input data collected during the same period of time as the period during which input data including n eCIR values is collected.

When the signal is classified as an LOS signal, the server may input the sequencing-processed first sensor input data as input data for training the second CNN model, and may perform processing for pose classification using the second CNN model in operation 809. For example, by using input data, the second CNN model may perform an operation of predicting whether a pose associated with the corresponding sensor input data is a first pose (e.g., handheld) or a second pose (e.g., front pocket). The server may obtain a predicted value (second predicted value or second predicted information) output from the second CNN model in operation 810. According to an embodiment, the predicted value may include a predicted probability value for a label (e.g., label 1) corresponding to the first pose (e.g., handheld (LOS)) and a predicted probability value for a label (e.g., label 2) corresponding to the second pose (e.g., front pocket (LOS)), in association with the first sensor input data associated with an LOS.

When the signal is classified as an NLOS signal, the server may input the sequencing-processed second sensor input data as input data for training the third CNN model, and may perform processing for pose classification using the third CNN model in operation 811. For example, by using input data, the third CNN model may perform an operation of predicting whether a pose associated with the corresponding sensor input data is a third pose (e.g., handheld (NLOS)) or a fourth pose (e.g., back pocket (NLOS)). The server may obtain a predicted value (second predicted value or second predicted information) output from the third CNN model in operation 812. According to an embodiment, the predicted value associated with the second sensor input data associated with an LOS may include a predicted probability value for a label (e.g., label 3) corresponding to the third pose (e.g., handheld (NLOS)) and a predicted probability value for a label (e.g., label 4) corresponding to the fourth pose (e.g., back pocket (NLOS)).

The server may obtain a ground truth value (second ground truth value or second ground truth information) associated with the corresponding pose in operation 813. According to an embodiment, the second ground truth value may include a ground truth probability value for a label (e.g., label 1) corresponding to the first pose, a ground truth probability value for a label (e.g., label 2) corresponding to the second pose, a ground truth probability value for a label (e.g., label 3) corresponding to the third pose, and/or a ground truth probability value for a label (e.g., label 4) corresponding to the fourth pose.

In operation 814, by using a loss function, the server may calculate a loss between the second predicted value of operation 810 and the second ground truth value of operation 813 and a gradient value, and/or may calculate a loss between the third predicted value of operation 812 and the second ground truth value of operation 813 and a gradient value.

The server may update parameters of the corresponding CNN model (second CNN model or third CNN model) by using the value obtained in operation 814. For example, the server may update the parameters of the second CNN model using the loss obtained based on the second predicted value of operation 810 and the second gradient truth value of operation 813 and/or gradient. Alternatively, the server may update the parameters of the third CNN model using the loss obtained based on the third predicted value of operation 812 and the second gradient truth value of operation 813 and/or gradient. According to an embodiment, by using a back-propagation scheme, the server may update the parameters of the corresponding CNN model to decrease a loss.

The parameters updated as described above may be used for the corresponding CNN model in order to process subsequent input data (e.g., subsequent m IMU sensing values).

By performing the above-described training procedure 800 with respect to all of the collected IMU sensor data sets (e.g., each IMU sensor data set includes m IMU sensing values), the server may continuously update parameters of the second CNN model and third CNN model (CNN parameters) to decrease a loss. The user device may obtain or download the trained CNN parameters of the second CNN model and the third CNN model.

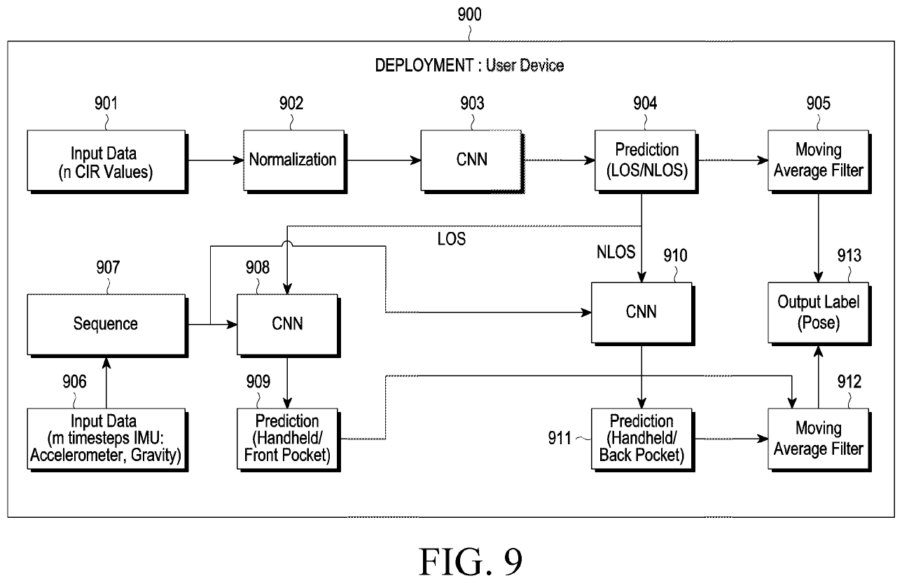

FIG. 9 is a diagram illustrating a deployment procedure for classifying a pose based on LOS/NLOS signal classification performed using UWB channel impulse response data according to an embodiment of the disclosure.

In the embodiment of FIG. 9, for ease of description, it is assumed that a deployment procedure 900 is performed in a user device.

With reference to FIG. 9, the deployment procedure 900 will be described.

In the deployment procedure 900, the user device may collect input data in operation 901. For example, the user device may collect a plurality of CIR values (e.g., eCIR values) as input data, and may divide the same based on a predetermined number of lengths (sizes) (e.g., n lengths) and process the same. According to an embodiment, the length (n) may be the same as a length (n) used for training.

The user device may perform CIR normalization with respect to the collected input data in operation 902. For example, the user device may normalize the collected input data to a range of 0 to 1. In this instance, the CIR normalization of operation 902 is an optional operation and may be omitted.

The user device may input CIR normalized data or CIR non-normalized data as input data of a first CNN model, and may perform processing for LOS/NLOS classification using the first CNN model in operation 903. In the disclosure, the first CNN model is referred to as a CNN model used for LOS/NLOS classification.

The user device may obtain a predicted value (first predicted value or first predicted information) output from the first CNN model in operation 904. According to an embodiment, the first predicted value may include a predicted probability value for a label (e.g., label a) corresponding to an LOS signal and a predicted probability value for a label (e.g., label b) corresponding to an NLOS signal.

The user device may perform the above-described LOS/NLOS classification procedure with respect to each of the all collected eCIR sets (e.g., each eCIR set includes n eCIR values). In operation 905, by using a moving average filter, the user device may perform filtering of predicted data (first predicted data) including each predicted value obtained from the first CNN model.

Based on a predicted value for a corresponding eCIR set, the user device may determine a signal corresponding to the corresponding eCIR set is classified as an LOS signal or an NLOS signal. For example, in the predicted value for the corresponding eCIR set, if a predicted probability value corresponding to an LOS signal is greater than a predicted probability value corresponding to an NLOS signal, the user device may determine that the signal corresponding to the corresponding eCIR set is classified as an LOS signal. As another example, in the predicted value for the corresponding eCIR set, if a predicted probability value corresponding to an NLOS signal is greater than a predicted probability value corresponding to an LOS signal, the user device may determine that the signal corresponding to the corresponding eCIR set is classified as an NLOS signal.

In the case in which the signal corresponding to the corresponding eCIR set is classified as an LOS signal, a classification procedure associated with pose detection based on a second CNN model may be performed. Alternatively, in the case in which the signal corresponding to the corresponding eCIR set is classified as an NLOS signal, a classification procedure associated with pose detection based on a third CNN model may be performed. In the disclosure, the second CNN model is referred to as a CNN model used for pose classification, which is trained using IMU sensor data associated with an LOS signal. In the disclosure, the third CNN model is referred to as a CNN model used for pose classification, which is trained using IMU sensor data associated with an NLOS signal.

The user device may collect sensor input data in operation 906. The sensor input data may be sensor input data (first sensor input data) associated with an LOS signal or sensor input data associated with an NLOS signal (second sensor input data). According to an embodiment, the sensor input data may include IMU values associated with m timestpes.

The user device may perform sequencing processing in order to input, to the second CNN model or third CNN model, sensor input data corresponding to input data of the first CNN model in operation 907. For example, the user device may perform sequencing processing in order to input, to the second CNN model or third CNN model, sensor input data collected during the same period of time as the period during which input data including n eCIR values is collected.

When the signal is classified as an LOS signal, the user device may input the sensor input data (first sensor input data) as input data of the second CNN model, and may perform processing for pose classification using the second CNN model in operation 908. For example, by using input data, the second CNN model may perform an operation of predicting whether a pose associated with the corresponding sensor input data is a first pose (e.g., handheld (LOS)) or a second pose (e.g., front pocket (LOS)). The user device may obtain a predicted value (second predicted value or second predicted information) output from the second CNN model in operation 909. According to an embodiment, the predicted value may include a predicted probability value for a label (e.g., label 1) corresponding to a first pose (e.g., handheld (LOS)) and a predicted probability value for a label (e.g., label 2) corresponding to a second pose (e.g., front pocket (LOS)), in association with the first sensor input data associated with an LOS.

When the signal is classified as an NLOS signal, the server may input the sequencing-processed sensor input data (second sensor input data) as input data for training the third CNN model, and may perform processing for pose classification using the third CNN model in operation 910. For example, by using input data, the third CNN model may perform an operation of predicting whether a pose associated with the corresponding sensor input data is a third pose (e.g., handheld (NLOS)) or a fourth pose (e.g., back pocket (NLOS)). The user device may obtain a predicted value (second predicted value or second predicted information) output from the third CNN model in operation 911. According to an embodiment, the predicted value may include a predicted probability value for a label (e.g., label 1) corresponding to a third pose (e.g., handheld (NLOS)) and a predicted probability value for a label (e.g., label 4) corresponding to a fourth pose (e.g., front pocket (NLOS)), in association with the second sensor input data associated with an NLOS.

The user device may perform the above-described pose classification procedure with respect to each of all IMU sensor data sets (e.g., each IMU sensor data set includes m IMU sensing values). In operation 912, by using a moving average filter, the user device may perform filtering of predicted data (second predicted data) including each predicted value obtained from the second CNN model, or may perform filtering of predicted data (third predicted data) including each predicted value obtained from the third CNN model. As described above, before final LOS/NLOS signal classification and final pose classification, by providing filtering that uses a moving average filter for predicted data output from each CNN model, accuracy of LOS/NLOS signal and pose classification may be increased.

The user device may determine a pose by using the filtered first predicted data and the filtered second predicted data. For example, by using the filtered first predicted data and the filtered second predicted data, whether the corresponding pose is a first pose (e.g., hand (LOS) pose) or a second pose (e.g., front (LOS)) may be determined.

Alternatively, the user device may determine a pose by using the filtered first predicted data and the filtered third predicted data. For example, by using the filtered first predicted data and the filtered third predicted data, whether the corresponding pose is a third pose (e.g., hand (NLOS) pose) or a fourth pose (e.g., back (NLOS)) may be determined.

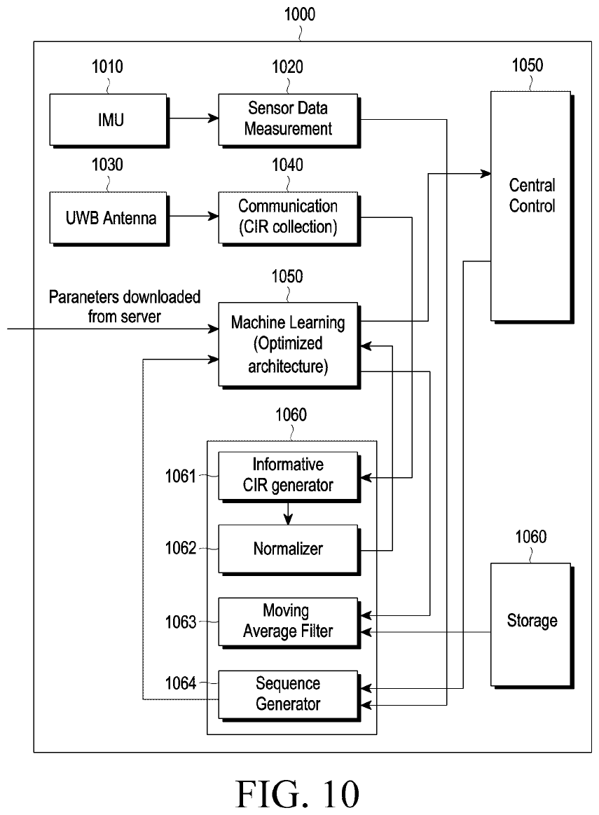

FIG. 10 is a diagram illustrating a configuration of a user device for pose classification using LOS/NLOS classification according to an embodiment of the disclosure.

Referring to FIG. 10, a user device 1000 may include an IMU sensor 1010, a sensor data collector 1020, a UWB antenna 1030, a CIR collector 1040, a machine learning unit 1050, a classification processor 1060, a central controller 1070, and/or a storage 1080. The classification processor 1060 may include an effect CIR generator 1061, a normalizer 1062, a moving average filter 1063 and/or a sequence generator 1064.

According to an embodiment, some of the above-described components may be omitted or an additional component may be further included. According to an embodiment, two or more components among the above-described components may be combined into a single component. According to an embodiment, the whole or part of the above-described components may be embodied by at least one processor. For example, components excluding the IMU sensor 1010, the UWB antenna 1030, and the storage 1080 may be embodied by at least one processor (or controller).

The IMU sensor 1010 may sense its surrounding environment. According to an embodiment, the IMU sensor 1010 may be a sensor capable of measuring a body's predetermined force, an angular rate, and/or a body's orientation by using a combination of an accelerometer, a gyroscope, and/or a magnetometer. The IMU sensor 1010 may transfer sensing data to the sensor data collector 1020.

The sensor data collector 1020 may transfer collected sensor data to the sequence generator 1064.

The sequence generator 1064 may perform sequencing processing in order to input, to a second CNN model or third CNN model, sensor input data corresponding to input data of a first CNN model. For example, the sequence generator 1064 may perform sequencing processing in order to input, to the second CNN model or third CNN model, sensor input data collected during the same period of time as the period during which input data including n eCIR values is collected.

The UWB antenna 1030 may receive at least one UWB signal from another electronic device. For example, the UWB antenna 1030 may receive at least one UWB signal for DS-TWR or at least one UWB signal for DL-TDoA.

The CIR collector 1040 may collect CIR data from at least one UWB signal received via the UWB antenna 1030. The CIR collector 1040 may transfer the collected CIR data to the effective CIR generator 1061. The collected CIR data may include a plurality of CIR values.

The effective CIR generator 1061 may generate effective CIR data from the collected CIR data. The effective CIR generator 1061 may transfer the generated effective CIR data to the normalizer 1062, or may directly transfer the same to the machine learning unit 1050. The effective CIR data may include a plurality of effective CIR values, and may be processed by the machine learning unit 1050 in units of a predetermined number of values (e.g., in units of n values).

The normalizer 1062 may normalize values of the effective CIR (eCIR) data. For example, the normalizer 1062 may normalize the values of the effective CIR data to values in the range of 0 to 1. The normalizer 1062 may be an optional configuration. For example, the normalizer 1062 may not be included in the user device 1000, or processing by the normalizer 1062 may be omitted although the normalizer 742 is included in the user device 1000.

The machine learning unit 1050 may generate predicted data using input data. According to an embodiment, the machine learning unit 730 may generate at least one predicted data using at least one CNN model, and the CNN parameters of each CNN model may be downloaded from a server in which a training procedure is performed in advance.

According to an embodiment, by using the first CNN model, the machine learning unit 1050 may generate first predicted data for LOS/NLOS classification from input effective CIR data. According to an embodiment, the first CNN model may perform processing in units of a predetermined number of eCIRs (e.g., neCIRs) (eCIR set), and may output a predicted value for each corresponding eCIR set. For example, the first predicted data may include a predicted value (first predicted value) for first n eCIRs (first eCIR set), a predicted value (second predicted value) for subsequent n eCIRs (second eCIR set), . . . , and a predicted value (n^{th} predicted value) for n^{th} n eCIRs (n^{th} eCIR set). Each predicted value may include a predicted probability value corresponding to an LOS and a predicted probability value corresponding to an NLOS, in association with the corresponding eCIR set.

According to an embodiment, by using the second CNN model, the machine learning unit 1050 may generate, from input sensor data, second predicted data for classifying a pose associated with an LOS. According to an embodiment, the second CNN model may perform processing in units of a predetermined number of sensing values (e.g., m sensing values) (sensor data set), and may output a predicted value for each corresponding eCIR set. For example, the second predicted data may include a predicted value (first predicted value) for first m sensing values (first sensing data set), a predicted value (second predicted value) for subsequent m sensing values (second sensing data set), . . . , and a predicted value (n^{th} predicted value) for n^{th} m sensing values (n^{th} sensing data set). Each predicted value may include a predicted probability value corresponding to a first pose and a predicted probability value corresponding to a second pose, associated with an LOS, in association with the corresponding sensing data set.

According to an embodiment, by using the third CNN model, the machine learning unit 1050 may generate, from input sensor data, third predicted data for classifying a pose associated with an NLOS. According to an embodiment, the third CNN model may perform processing in units of a predetermined number of sensing values (e.g., m sensing values) (sensor data set), and may output a predicted value for each corresponding sensing data set. For example, the third predicted data may include a predicted value (first predicted value) for first m sensing values (first sensing data set), a predicted value (second predicted value) for subsequent m sensing values (second sensing data set), . . . and a predicted value (n^{th} predicted value) for n^{th} m sensing values (n^{th} sensing data set). Each predicted value may include a predicted probability value corresponding to a first pose and a predicted probability value corresponding to a second pose, associated with an NLOS, in association with the corresponding sensing data set.

The machine learning unit 1050 may transfer predicted data (e.g., first predicted data, second predicted data, and/or third predicted data) to the central controller 1070 and/or moving average filter 1064.

The central controller 1070 may transfer the received predicted data to the storage 1080. The storage 1080 may store the received predicted data, and may transfer the stored predicted data to the moving average filter 1064.

The moving average filter 1064 may filter each predicted data. The filtered predicted data may be used for final pose classification. The filtered predicted data may be used by various applications. According to an embodiment, an application may provide different services or service-related parameters (e.g., thresholds) according to a pose classified based on the filtered predicted data.

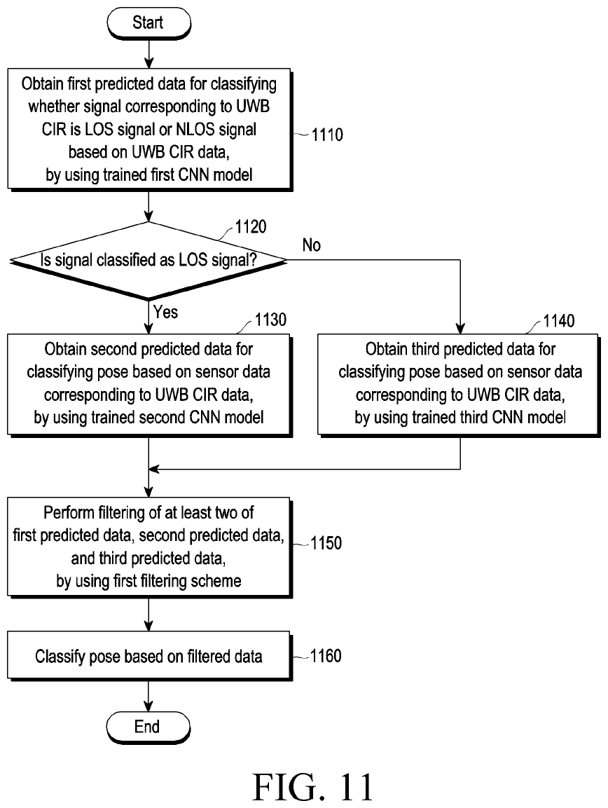

FIG. 11 is a diagram illustrating a pose classification method of an electronic device according to an embodiment of the disclosure.

In the embodiment of FIG. 11, the electronic device may be a user's electronic device (user device). A description of each operation of FIG. 11 may refer to the description of the operations/steps described above with reference to FIGS. 4 to 10, unless they are contradictory to each other.

Referring to FIG. 11, the electronic device may obtain first predicted data for classifying whether a signal corresponding to a UWB CIR is an LOS signal or an NLOS signal based on UWB CIR data, by using a trained first CNN model, in operation 1110.

The electronic device may identify whether the signal is classified as an LOS signal, in operation 1120.

When the signal is classified as an LOS signal, the electronic device may obtain second predicted data for classifying a pose based on sensor data corresponding to the UWB CIR data, by using a trained second CNN model, in operation 1130.

When the signal is classified as an LOS signal, the electronic device may obtain third predicted data for classifying a pose based on sensor data corresponding to the UWB CIR data, by using a trained third CNN model, in operation 1140.

The electronic device may perform filtering of at least two of the first predicted data, second predicted data, and third predicted data by using a first filtering scheme in operation 1150.

The electronic device may classify a pose based on the filtered data in operation 1160.

According to an embodiment, the second CNN model may be trained using sensor data associated with an LOS signal and the third CNN model may be trained using sensor data associated with an NLOS signal.

According to an embodiment, when the signal is classified as an LOS signal, the electronic device may classify one of at least one pose associated with an LOS signal as a pose based on the filtered first predicted data and filtered second predicted data.

According to an embodiment, when the signal is classified as an NLOS signal, the electronic device may classify one of at least one pose associated with an NLOS signal as a pose based on the filtered first predicted data and filtered third predicted data.

According to an embodiment, the first filtered scheme may be a moving average filter scheme.

According to an embodiment, the sensor data may be sensor data obtained from the IMU sensor.

According to an embodiment, the UWB CIR data may include effective CIR data obtained by removing noise from CIR data obtained based on UWB signals for DL-TDoA ranging, or may include effective CIR data obtained by removing noise from CIR data obtained based on UWB signals for DS-TWR ranging.

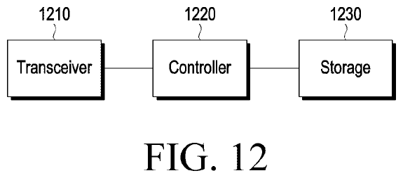

FIG. 12 is a diagram illustrating a structure of an electronic device according to an embodiment of the disclosure.

In the embodiment of FIG. 12, the electronic device may be a user's electronic device (user device) or a server.

Referring to FIG. 12, the electronic device may include a transceiver 1210, a controller 1220, and a storage 1230. In the disclosure, the controller may be defined as a circuit, an application-specific integrated circuit, or at least one processor.

The transceiver 1210 may perform signal transmission or reception with another network entity. The transceiver 1210, for example, may perform data transmission or reception for commissioning.

The controller 1220 may control the overall operation of the electronic device according to the embodiments of the disclosure. For example, the controller 1220 may control a signal flow in blocks so that operations based on the above-described flowchart are performed. Specifically, the controller 1220, for example, may control the operation of the electronic device that has been described with reference to FIGS. 1 to 11.

The storage 1230 may store at least one piece of information among information transmitted or received via the transceiver 1210 and information produced by the controller 1220. For example, the storage 1230, for example, may store information and data needed for pose classification, which has been described with reference to FIGS. 1 to 11.

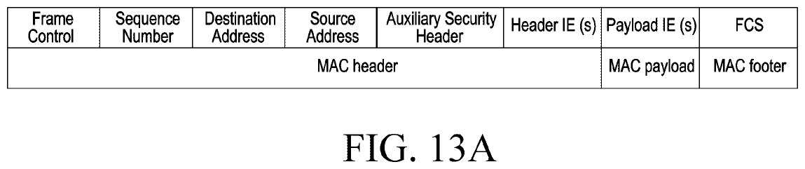

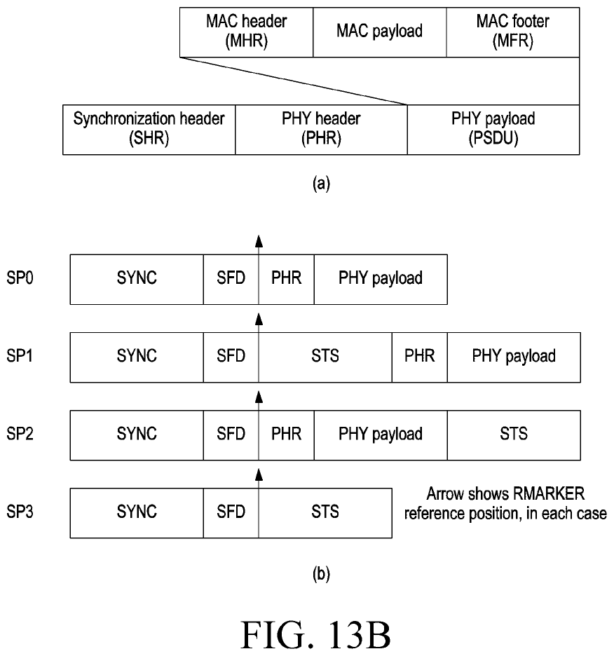

FIG. 13A is a diagram illustrating a structure of a UWB MAC frame according to an embodiment of the disclosure.

In the disclosure, the UWB MAC frame may be referred to as a MAC frame or frame for short. According to an embodiment, the UWB MAC frame may be used for transferring UWB-related data (e.g., UWB message, ranging message, control information, service data, application data, or the like).

Referring to FIG. 13A, the UWB MAC frame may include a MAC header (MHR), a MAC payload, and/or a MAC footer (MFR).

### (1) MAC Header

The MAC header may include a frame control field, a sequence number field, a destination address field, a source address field, an auxiliary security header field, and/or at least one header IE field. According to an embodiment, some of the above-described fields may not be included in the MAC header, or an additional field(s) may be further included in the MAC header.

According to an embodiment, the frame control field may include a frame type field, a security enabled field, a frame pending field, an ack request (AR) field, a PAN ID compression field (PAN ID present field), a sequence number suppression field, an IE present field, a destination addressing mode field, a frame version field, and/or a source addressing model field. According to an embodiment, some of the above-described fields may not be included in the frame control field, or an additional field(s) may be further included in the frame control field.

A description of each field is as follows.

A frame type field may indicate a frame type. According to an embodiment, a frame type may include a data type and/or a multipurpose type.

A security enabled field may indicate whether an auxiliary security header field exists. The auxiliary security header field may include information required for security processing.

A frame pending field may indicate whether a device that transmits a frame has more data for a recipient. That is, the frame pending field may indicate whether a pending frame exists for a recipient.

An ack request (AR) field may indicate whether an acknowledgement for reception of a frame is required from a recipient.

A PAN ID compression field (PAN ID present field) may indicate whether a PAN ID field exists.

A sequence number suppression field may indicate whether a sequence number field exists. The sequence number field may indicate a sequence identifier for a frame.

An IE present field may indicate whether a header IE field and a payload IE field are included in a frame.

A destination addressing mode field may indicate whether a destination address field includes a short address (e.g., 16 bits) or an extended address (e.g., 64 bits). The destination address field may indicate an address of a recipient of a frame.

A frame version field may indicate a frame version. For example, the frame version field may be configured to a value indicating IEEE std 802.15.4z-2020.

A source addressing mode field may indicate whether a source address field exists, and, when a source address field exists, may indicate whether the source address field includes a short address (e.g., 16 bits) or an extended address (e.g., 64 bits). The source address field may indicate an address of an originator of a frame.

### (2) MAC Payload

The MAC payload may include at least one payload IE field. According to an embodiment, a payload IE field may include a vendor specific nested IE.

### (3) MAC Footer

The MAC footer may include a FCS field. The FCS field may include a 16-bit CRC or a 32-bit CRC.

FIG. 13B is a diagram illustrating a structure of a UWB PHY packet according to an embodiment of the disclosure.

Part A of FIG. 13B illustrates a structure of a UWB PHY packet to which an STS packet configuration is not applied, and part B of FIG. 13B illustrates a structure of a UWB PHY packet to which an STS packet configuration is applied. The UWB PHY packet may be referred to as a PHY packet, a PHY PDU (PPDU), or a frame.

Referring to part A of FIG. 13B, a PPDU may include a synchronization header (SHR), a PHY header (PHR), and a PHY payload (PSDU). The PSDU may include a MAC frame, and as illustrated in FIG. 2, the MAC frame may include a MAC header (MHR), a MAC payload, and/or a MAC footer (MFR). A synchronization header part may be referred to as a preamble, and a part including the PHY header and the PHY payload may be referred to as a data part.

The synchronization header may be used for synchronization for signal reception, and may include a SYNC field and a start-of-frame delimiter (SFD).

The SYNC field may be a field including a plurality of preamble symbols used for synchronization between transmission/reception devices. The preamble symbol may be configured by one of predefined preamble codes.

An SFD field may be a field indicating an end of the SHR and a start of a data field.

The PHY header may provide information associated with a configuration of the PHY payload. For example, the PHY header may include information associated with a length of a PSDU, information indicating whether a current frame is a RFRAME (or data frame), or the like.

A PHY layer of a UWB device may include an optional mode for providing a decreased on-air time for a high density/low power operation. In this instance, a UWB PHY packet may include a ciphered sequence (i.e., STS) for increasing integrity and accuracy of a ranging measurement timestamp. The STS may be included in an STS field of a UWB PHY packet, and may be used for security ranging.

Referring to part B of FIG. 13B, in the case of STS packet (SP) configuration 0 (SP0), an STS field may not be included in the PPDU (SP0 packet). In the case of STS configuration 1 (SP1), an STS field may be immediately after a start of frame delimiter (SFD) field and before a PHR field (SP1 packet). In the case of SP configuration 2 (SP2), an STS field may be after a PHY payload (SP2 packet). In the case of SP configuration 3 (SP3), an STS field may be immediately after an SFD field, and the PPDU may not include a PHR and data field (PHY payload) (SP3 packet). That is, in the case of SP3, the PPDU may not include a PHR and a PHY payload.

As illustrated in part B of FIG. 13B, each UWB PHY packet may include RMARKER to define a reference time, and the RMARKER may be used for obtaining a transmission time (transmission timestamp) of a ranging message (frame), a reception time (reception timestamp), and/or a time interval in a UWB ranging procedure. For example, a UWB PHY packet may include RMARKER in a preamble or the end of the preamble.

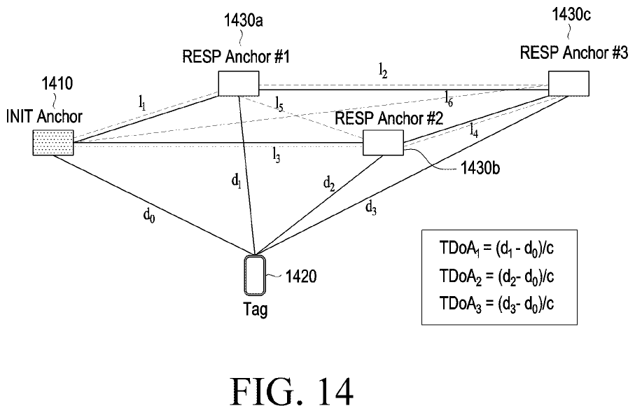

FIG. 14 is a diagram illustrating an example of a cluster configured with a plurality of UWB anchors according to an embodiment of the disclosure.

The cluster may be a set of UWB anchors (DT-anchors) that exchange DTMs with each other, in order to provide a positioning service to a UWB tag. For example, as illustrated in FIG. 14, the cluster may be a set including a single initiator anchor (initiator DT-anchor) 1410 and three responder anchors (responder DT-anchors) 1430a, 1430b, and 1430c. In this instance, the embodiment is not limited thereto, and the number of UWB anchors included in a cluster, and the number of initiator anchors and responder anchors may be configured variously according to embodiments.

According to an embodiment, a UWB anchor may operate in one or more clusters. In this instance, a UWB anchor that operates as an initiator anchor in one cluster may operate as a responder anchor in another cluster.

According to an embodiment, an area covered by one cluster may overlap an area covered by an adjacent cluster.

Referring to FIG. 14, a UWB tag 1420 may receive DTMs exchanged between UWB anchors 1410, 1430a, 1430b, and 1430c, and may calculate TDoAs associated with multiple pairs of anchor devices based on the received DTMs. For example, based on the received DTMs, the UWB tag 1420 may calculate TDoA₁ that is a TDoA between the initiator anchor 1410 and the responder anchor 1430a, TDoA₂ that is a TDoA between the initiator anchor 1410 and the responder anchor 1430b, and TDoA₃ that is a TDoA between the initiator anchor 1410 and the responder anchor 1430c. The UWB tag 1420 may estimate (or determine) its position by using the calculated TDoAs.

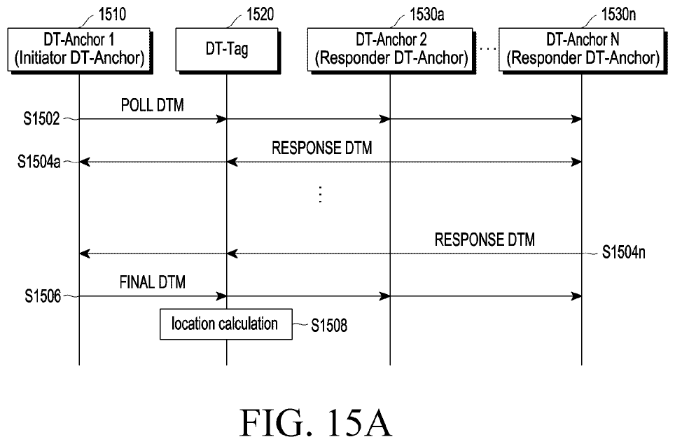

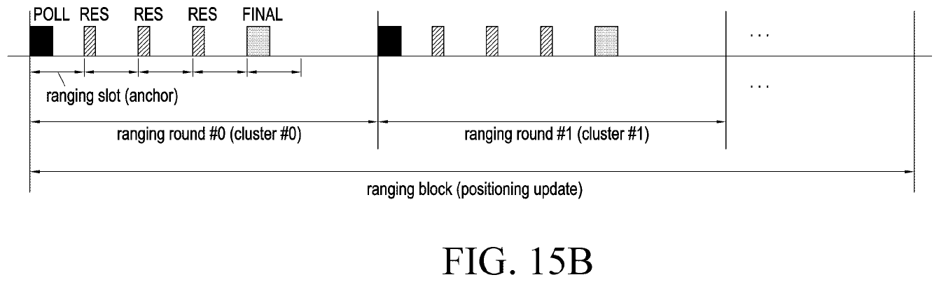

FIG. 15A is a diagram illustrating a method of performing UWB ranging based on a DL-TDoA scheme by a UWB device according to an embodiment of the disclosure.

In the embodiment of FIG. 15A, it is assumed that one initiator anchor (initiator DT-anchor) 1510 and n responder anchors (responder DT-anchors 1530a, . . . , 1530n) operate as UWB anchors (DT-anchor). For example, as illustrated in FIG. 14, one initiator anchor and three responder anchors may operate as UWB anchors. In this instance, the embodiment is not limited thereto, and the number of UWB anchors included in a cluster, and the number of initiator anchors and responder anchors may be configured variously according to embodiments.

In operation S1502, the initiator anchor 1510 may transmit or broadcast a poll DTM that responder anchors in the cluster receive, and may initiate a DL-TDoA round. The poll DTM may include scheduling information (e.g., ranging slot index) associated with each responder anchor in order to transmit a response DTM in an allocated ranging slot. The poll DTM may further include transmission time information (transmission timestamp) indicating a time at which the poll DTM is transmitted. The poll DTM may further include a round index of a current ranging round and a block index of a current ranging block at which the poll DTM is transmitted. The poll DTM may further include position information of a UWB anchor that transmits the poll DTM.

According to an embodiment, each responder anchor 1530a . . . , and 1530n may identify whether to transmit a response DTM and/or a slot (ranging slot index) that is used for transmitting its response DTM, by referring to scheduling information in the poll DTM.

In operations S1504a . . . and S1504n, each responder anchor 1530a . . . , and 1530n that receives the poll DTM may provide a response to the initiator anchor 1510 by using a response DTM in a ranging slot allocated by the poll DTM. For example, each responder anchor 1530a . . . and 1530n may transmit or broadcast a response DTM in its ranging slot allocated by the poll DTM. Each response DTM may include reply time information indicating a time between a time at which the poll DTM is received and a time at which a corresponding response DTM is transmitted. Each response DTM may include a transmission time (transmission timestamp) indicating a time at which the corresponding response DTM is transmitted. Each response DTM may further include a round index of a current ranging round and a block index of a current ranging block at which the corresponding response DTM is transmitted. Each response DTM may further include position information of a UWB anchor that transmits the corresponding response DTM.

In operation S1506, the initiator anchor 1510 that receives response DTMs may additionally transmit a final DTM to the responder anchors 1530a, . . . , and 1530n. For example, the initiator anchor 1510 may transmit or broadcast the final DTM after receiving the response DTMs from the responder anchors 1530a . . . , and 1530n. The final DTM may include each reply time indicating a time between a time at which each response DTM is received and a time that the final DTM is transmitted. That is, the final DTM may include a list of reply times, and the list may include reply times indicating times between times at which respective response DTMs are received and the time at which the final DTM is transmitted. The final DTM may include a transmission time (transmission timestamp) indicating a time at which the final DTM is transmitted. The final DTM may further include a round index of a current ranging round and a block index of a current ranging block at which the final DTM is transmitted.

In operation S1508, a tag device (DT-tag) 1520 may receive (or overhear) the poll DTM, response DTMs, and final DTM, may obtain information included in each DTM message and reception time information (reception timestamp) indicating a time at which each DTM message is received, and may calculate TDoA values using the obtained information. The tag device 1520 may obtain (or estimate) its position by using the calculated TDoA values. For example, the tag device 1520, that is a user device, may calculate relative distances to anchor devices by using TDoAs associated with multiple pairs of anchor devices, and may estimate its position. Through the above, the tag device 1520 may estimate its position without exposure of its position.

Above-described each DTM may be included in a MAC frame (e.g., MAC frame of FIG. 13A) and may be transmitted via a UWB signal (or a PHY packet (e.g., PHY packet of FIG. 13B)).

FIG. 15B is a diagram illustrating an example of a ranging block structure for a downlink TDoA scheme according to an embodiment of the disclosure.

The ranging block structure of FIG. 15B is an example of a ranging block structure for performing the ranging scheme of FIG. 15A.

Referring to FIG. 15B, a ranging block may include a plurality of ranging rounds.

According to an embodiment, the ranging block may include a plurality of ranging rounds allocated respectively to a plurality of clusters. For example, in the case of n clusters are arranged, a ranging block may include a first ranging round allocated for a first cluster, a second ranging round allocated for a second cluster, . . . and an n^{th} ranging round allocated for an n^{th} cluster. Although not illustrated in FIG. 7B, according to an embodiment, a plurality of ranging rounds may be allocated to a single cluster, and a single ranging round may be allocated to a plurality of clusters.

According to an embodiment, a ranging round may include a plurality of ranging slots. A ranging round may include a plurality of ranging slots allocated for ranging messages transmitted by anchor devices belonging to a cluster associated with the corresponding ranging round. For example, in the case in which a first cluster is configured with one initiator anchor and three responder anchors, a ranging round for the first cluster may a first ranging slot (e.g., ranging slot index 0) allocated for transmission/reception of a poll message of the initiator anchor included in the first cluster, a second ranging slot allocated for transmission/reception of a response message of a first responder anchor, a third ranging slot allocated for transmission/reception of a response message of a second responder anchor, a fourth ranging slot allocated for transmission/reception of a response message of a third responder anchor, and a fifth ranging slot allocated for transmission/reception of a final message of the initiator anchor.

In this manner, ranging slots may be allocated to a ranging round for each cluster.

Via the ranging block structure as illustrated in FIG. 15B, anchor devices of each cluster may exchange ranging messages of one cycle via their ranging rounds in one ranging block, and a user device (tag device) may receive the ranging messages and may calculate its position. The operation may be repeated for each ranging block. Through the above, the position of the user device may be updated based on a ranging block-cycle.

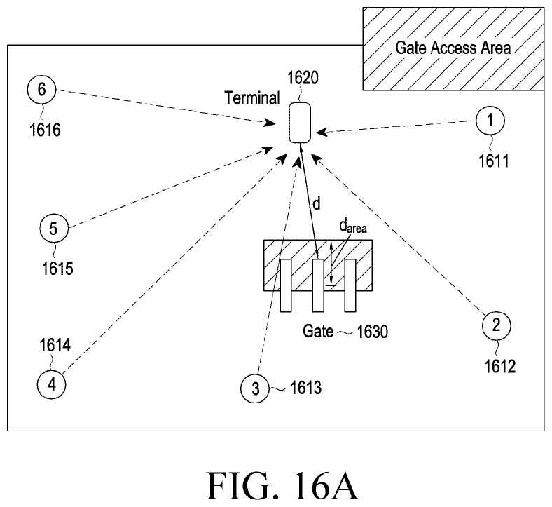

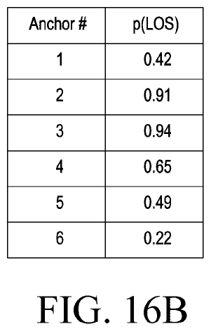

FIG. 16A is a diagram illustrating an example of an LOS environment in the case of DL-TDoA positioning according to an embodiment of the disclosure.

In FIG. 16A, for ease of description, it is assumed that 6 UWB anchors for DL-TDoAs and one user device (terminal) exist in a gate access area where a gate is located. In this instance, the embodiment is not limited thereto, and the number of UWB anchors for DL-TDoAs and the number of user devices may be variously configured.

Referring to FIG. 16A, a user device 1620 may receive a UWB signal for a DL-TDoA from each UWB anchor 1611, 1612, 1613, 1614, 1615, and 1616. For example, the user device 1620 may receive a UWB signal including a poll DTM and/or a UWB signal including a final DTM from an initiator anchor. For example, the user device 1620 may receive a UWB signal including a response DTM from each responder anchor.

The user device 1620 may obtain information (reception timestamp) associated with reception times at which UWB signals are received respectively from n neighboring UWB anchors, and may use the obtained n reception timestamps for DL-TDoAs. For example, in the case of three-dimensional (3D) DL-TDoA positioning, UWB signals received from at least four UWB anchors are needed for DL-TDoA positioning, and thus the user device 1620 may select four reception timestamps among the n reception timestamps so as to estimate its position.

According to an embodiment, the user device 1620 may select a combination of four reception timestamps selectable from the n reception timestamps, and may estimate its position using each reception timestamp combination. In this instance, the user device may estimate its position based on each reception timestamp combination, and may determine an accurate position by removing a position having a highest variance and performing recalculation. That is, the user device may determine its position by performing calculation C(n,4) times.

A timestamp (reception timestamp) of a UWB signal may be measured using a first peak of a preamble of the UWB signal (e.g., a preamble of a UWB PHY packet included in the UWB signal). In the case in which a UWB signal is an LOS signal, one peak occurs, and thus the user device 1620 may clearly identify a first peak for a preamble of the corresponding UWB signal. Conversely, in the case in which a UWB signal is an NLOS signal, multiple peaks occur due to a multipath characteristic, and thus the user device 1620 may be difficult to clearly identify which peak is a first peak for a preamble of the corresponding UWB signal. Therefore, when the UWB signal is an NLOS signal, there is a high probability of having an error in a reception timestamp. The error of the reception timestamp may cause an error of DL-TDoA positioning.

Therefore, when the user device 1620 is capable of identifying an LOS quality (e.g., p(LOS)) for a corresponding UWB signal by using an LOS/NLOS classification method (e.g., the LOS/NLOS classification method described with reference to FIGS. 7 and 8), the user device 1620 may perform DL-TDoA positioning using only a reception timestamp of a UWB signal having a high LOS quality. For example, the user device 1620 may perform DL-TDoA positioning using only reception timestamps of UWB signals having top four p(LOS). Through the above, accurate positioning is enabled.

FIG. 16B is a diagram illustrating an example of LOS probability data for a UWB signal obtained in the DL-TDoA positioning environment of FIG. 16A.

By using an LOS/NLOS classification method (e.g., the LOS/NLOS classification method described with reference to FIGS. 7 and 8), the user device 1620 may obtain an LOS probability (LOS quality) for a UWB signal received from each UWB anchor.

For example, as illustrated in FIG. 16B, an LOS probability for a UWB signal received from the first UWB anchor 1611 may be 0.42 (p(LOS)=0.42), an LOS probability for a UWB signal received from the second UWB anchor 1612 may be 0.91 (p(LOS)=0.91), an LOS probability for a UWB signal received from the third UWB anchor 1613 may be 0.94 (p(LOS)=0.94), an LOS probability for a UWB signal received from the fourth UWB anchor 1614 may be 0.65 (p(LOS)=0.65), an LOS probability for a UWB signal received from the fifth UWB anchor 1615 may be 0.49 (p(LOS)=0.49), and an LOS probability for a UWB signal received from the sixth UWB anchor 1616 may be 0.22 (p(LOS)=0.22).

In the case in which n UWB anchors exist in the DL-TDoA environment, the average (P) of LOS probabilities of the n UWB anchors may be expressed as shown in Equation 1 below.

$$\overline{p} = \frac{\sum p ( {LOS}_{i} )}{n} \qquad [ Equation 1 ]$$

Here, n is the number of UWB anchors in the DL-TDoA environment, and p(LOS) is an LOS probability for a UWB signal received from an i^{th} UWB anchor.

According to an embodiment, when n UWB anchors exist in the DL-TDoA environment, a threshold value (pₜₕ) for distinguishing whether the DL-TDoA environment is an LOS environment or an NLOS environment may be configured. According to an embodiment, in the case of pₜₕ<^{p̅}, the DL-TDoA environment may be regarded as an LOS environment. In the case of pₜₕ>^{p̅}, the DL-TDoA environment may be regarded as an LOS environment. For example, a threshold value (pₜₕ) may be configured to distinguish whether the DL-TDoA environment is an LOS environment or an NLOS environment in a tagless gate, digital car key, or POS device. For example, the threshold value (pₜₕ) may be configured to 0.5.

Referring to FIGS. 16A and 16B, when the threshold value (p^{th}) is 0.5, ^{p̅}=0.605. Accordingly, the DL-TDoA environment illustrated in FIG. 16A may be regarded as an LOS environment (“pₜₕ<^{p̅}”).

Referring to FIG. 16A, based on a distance (d) between the user device 1620 and a gate 1630 and a distance value (dₐᵣₑₐ) based on a gate access area, the user device 1620) may determine whether to access the gate 1630. According to an embodiment, in the case of dₐᵣₑₐ<d, it is regarded that the user device 1620 is located outside the gate access area and the user device 1620 does not access the gate 1630. In the case of dₐᵣₑₐ≥d, it is regarded that the user device 1620 attempts to access the gate 1630.

According to an embodiment, in the case of an LOS environment, the user device 1620 may adaptively skip ranging, thereby causing a power saving effect.

An adaptive ranging frequency (fₐ) may be expressed as shown in Equation 2 below.

$${f}_{a} = f * ⌈ \frac{d}{{d}_{area}} ⌉ \qquad [ Equation 2 ]$$

Here, f denotes a ranging frequency in the corresponding DL-TDoA environment, d denotes a distance between the user device 1620 and the gate 1630, and dₐᵣₑₐ denotes a liner distance from the center of the gate 1630 to a gate access area. According to an embodiment, in the center of the gate 1630, a communication module (e.g., UWB module) that supports communication of the gate 1630 may be located. For example, in the case of f=200 ms, d=3 m, and dₐᵣₑₐ=2 m, fₐ=400 ms may be determined according to Equation 2.

According to an embodiment, in the case of dₐᵣₑₐ<d in the LOS environment, a

$$⌈ \frac{d}{{d}_{area}} ⌉$$

-fold power saving effect may be obtained by adaptively adjusting a ranging frequency. According to an embodiment, in the case of dₐᵣₑₐ>d in the LOS environment, an existing ranging frequency f may be used as it is.

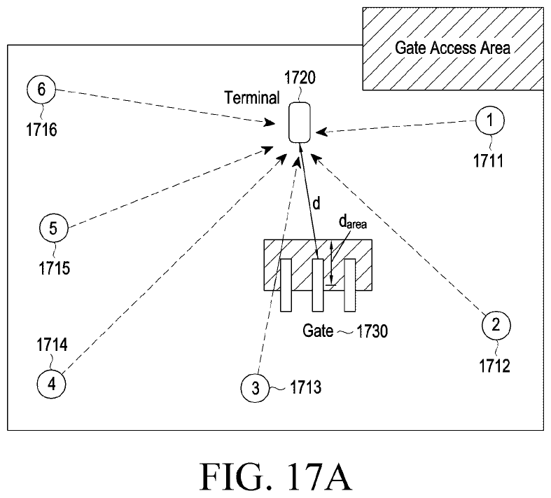

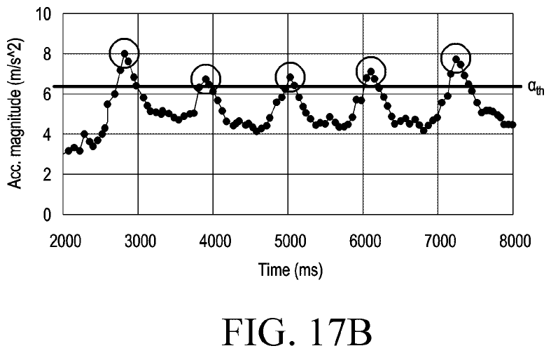

FIG. 17A is a diagram illustrating an example of an LOS environment in the case of DL-TDoA positioning according to an embodiment of the disclosure.

Referring to FIG. 17A, a user device 1720 may receive a UWB signal for a DL-TDoA from each UWB anchor 1711, 1712, 1713, 1714, 1715, and 1716. For example, the user device 1720 may receive a UWB signal including a poll DTM and/or a UWB signal including a final DTM from an initiator anchor. For example, the user device 1720 may receive a UWB signal including a response DTM from each responder anchor.

The user device 1720 may obtain information (reception timestamp) associated with reception times at which UWB signals are received respectively from n neighboring UWB anchors, and may use the obtained n reception timestamps for DL-TDoAs. For example, in the case of three-dimensional (3D) DL-TDoA positioning, UWB signals received from at least four UWB anchors are needed for DL-TDoA positioning, and thus the user device 1720 may select four reception timestamps among the n reception timestamps so as to estimate its position.

According to an embodiment, the user device 1720 may select a combination of four reception timestamps selectable from the n reception timestamps, and may estimate its position using each reception timestamp combination. In this instance, the user device may estimate its position based on each reception timestamp combination, and may determine an accurate position by removing a position having a highest variance and performing recalculation. That is, the user device may determine its position by performing calculation C(n,4) times.

FIG. 17B is a diagram illustrating an example of a graph associated with an acceleration value based on a movement of a user device in the DL-TDoA positioning environment of FIG. 17A.

According to an embodiment, when the user device 1720 does not move, a ranging frequency may be adjusted in order to reduce power. According to an embodiment, since DL-TDoA positioning is also utilized outside the gate access area, a ranging frequency may be adjusted when the user device 1720 does not move.

According to an embodiment, when the user device 1720 is moving, a peak may occur periodically in the magnitude of an acceleration value measured by an inertial measurement unit (IMU) sensor (e.g., the sensor module 176 of FIG. 1). The IMU sensor may be an inertial measurement device and may be configured as at least one of an acceleration sensor, an angular velocity sensor (gyroscope), or a geomagnetic sensor (magnetometer).

An acceleration value (aₘ) measured by the IMU sensor may be expressed as shown in Equation 3 below.

$${a}_{m} = \sqrt{{a}_{x}^{2} + {a}_{y}^{2} + {a}_{z}^{2}} \qquad [ Equation 3 ]$$

Here, aₓ denotes an acceleration in the x-axis, ay denotes an acceleration in the y-axis, and a_{z} denotes an acceleration in the z-axis.

According to an embodiment, a step function (H(aₘ)) based on a movement of the user device 1720 may be defined as shown in Equation 4 below.

$$H ( {a}_{m} ) = \{ \begin{matrix}1 , & if {a}_{m} - {a}_{th} > 0 \\ 0 , & else\end{matrix} \qquad [ Equation 4 ]$$

Here, aₜₕ denotes a threshold value for an acceleration value (aₘ) measured by the IMU sensor, which is defined to identify whether the user device 1720 is moving or not.

Referring to FIG. 17B, when peak values of acceleration values (aₘ) measured by the IMU sensor are greater than the threshold value (aₜₕ), the user device 1720 is regarded as moving at the corresponding point in time.

According to an embodiment, an adaptive ranging frequency (fₐ) in consideration of a movement of the user device 1720 may be expressed as shown in Equation 5 below.

$${f}_{a} = f * ⌈ \frac{d}{{d}_{area}} ⌉ * H ( {a}_{m} ) \qquad [ Equation 5 ]$$

Here, f denotes a ranging frequency in the corresponding DL-TDoA environment, d denotes a distance between the user device 1720 and the gate 1730, and dₐᵣₑₐ denotes a liner distance from the center of the gate 1730 to a gate access area.

According to an embodiment, in an interval where no movement of the user device 1720 exists, by minimizing ranging, a power saving effect for the user device 1720 may be obtained.

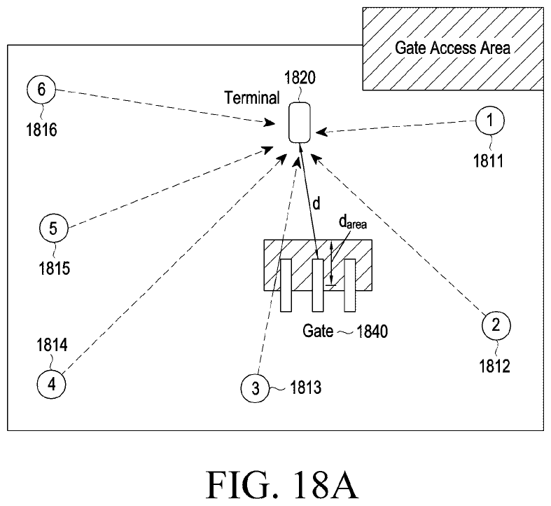

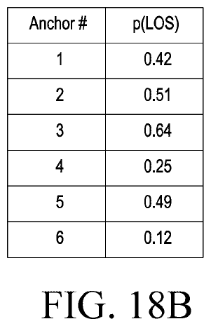

FIG. 18A is a diagram illustrating an example of an NLOS environment in the case of DL-TDoA positioning according to an embodiment of the disclosure.

In FIG. 18A, for ease of description, it is assumed that 6 UWB anchors for DL-TDoAs and one user device (terminal) exist in a gate access area where a gate is located. In this instance, the embodiment is not limited thereto, and the number of UWB anchors for DL-TDoAs and the number of user devices may be variously configured.

Referring to FIG. 18A, a user device 1820 may receive a UWB signal for a DL-TDoA from each UWB anchor 1811, 1812, 1813, 1814, 1815, and 1816. For example, the user device 1820 may receive a UWB signal including a poll DTM and/or a UWB signal including a final DTM from an initiator anchor. For example, the user device 1820 may receive a UWB signal including a response DTM from each responder anchor.

The user device 1820 may obtain information (reception timestamp) associated with reception times at which UWB signals are received respectively from n neighboring UWB anchors, and may use the obtained n reception timestamps for DL-TDoAs. For example, in the case of three-dimensional (3D) DL-TDoA positioning. UWB signals received from at least four UWB anchors are needed for DL-TDoA positioning, and thus the user device 1820 may select four reception timestamps among the n reception timestamps so as to estimate its position.

FIG. 18B is a diagram illustrating an example of LOS probability data for a UWB signal obtained in the DL-TDoA positioning environment of FIG. 18A.

By using an LOS/NLOS classification method (e.g., the LOS/NLOS classification method described with reference to FIGS. 7 and 8), the user device 1820 may obtain an LOS probability (LOS quality) for a UWB signal received from each UWB anchor.

For example, as illustrated in FIG. 18B, an LOS probability for a UWB signal received from the first UWB anchor 1811 may be 0.42 (p(LOS)=0.42), an LOS probability for a UWB signal received from the second UWB anchor 1812 may be 0.51 (p(LOS)=0.51), an LOS probability for a UWB signal received from the third UWB anchor 1813 may be 0.64 (p(LOS)=0.64), an LOS probability for a UWB signal received from the fourth UWB anchor 1814 may be 0.25 (p(LOS)=0.25), an LOS probability for a UWB signal received from the fifth UWB anchor 1815 may be 0.49 (p(LOS)=0.49), and an LOS probability for a UWB signal received from the sixth UWB anchor 1816 may be 0.12 (p(LOS)=0.12).

Referring to FIGS. 18A and 18B, when the threshold value (p^{th}) is 0.5, ^{p̅}=0.405. Accordingly, the DL-TDoA environment illustrated in FIG. 1A may be regarded as an NLOS environment (“pₜₕ>^{p̅}”).

In the NLOS environment, UWB signals received from the UWB anchors may need to maximally utilized so as to secure location estimation accuracy for the user device 1820. When ranging is arbitrarily skipped in the NLOS environment, there is high probability that tracking of the position of the user device 1820 is not properly performed.

According to an embodiment, in the NLOS environment, a plurality of UWB signals are received for each ranging interval, and only n UWB signals among the plurality of UWB signals may be utilized for positioning of the user device 1820.

Referring to FIGS. 18A and 18B, only four UWB signals having high p(LOS) among the plurality of UWB signals may be used when 3D positioning of the user device 1820 is performed. For example, when 3D positioning of the user device 1820 is performed, a UWB signal received from the first UWB anchor 1811, a UWB signal received from the second UWB anchor 1812, a UWB signal received from the third UWB anchor 1813, and a UWB signal received from the fifth UWB anchor 1815 may be utilized. Since ^{p̅}=0.515 with respect to the UWB signal received from the first UWB anchor 1811, the UWB signal received from the second UWB anchor 1812, the UWB signal received from the third UWB anchor 1813, and the UWB signal received from the fifth UWB anchor 1815, it is partially regarded as if it is an LOS environment (the case of pₜₕ=0.5), and the 3D positioning accuracy for the user device 1820 may be improved when compared to the method of using all UWB signals.

Referring to FIGS. 18A and 18B, only three UWB signals having high p(LOS) among the plurality of UWB signals may be used when 2D positioning of the user device 1820 is performed. For example, when 2D positioning of the user device 1820 is performed, a UWB signal received from the second UWB anchor 1812, a UWB signal received from the third UWB anchor 1813, and a UWB signal received from the fifth UWB anchor 1815 may be utilized. Since ^{p̅}=0.547 with respect to the UWB signal received from the second UWB anchor 1812, the UWB signal received from the third UWB anchor 1813, and the UWB signal received from the fifth UWB anchor 1815, it is regarded as if it is an LOS environment (the case of pₜₕ=0.5), and the 2D positioning accuracy for the user device 1820 may be improved when compared to the method of using all UWB signals.

According to an embodiment, in the case of ^{p̅}<pₜₕ with respect to top n signals having high p(LOS) among all UWB signals in the NLOS environment, a process for positioning of the user device 1820 may be skipped. According to an embodiment, when a process for positioning the user device 1820 is skipped, a process of calculating the position of the user device 1820 is abandoned, and thus the amount of power consumption may be decreased.

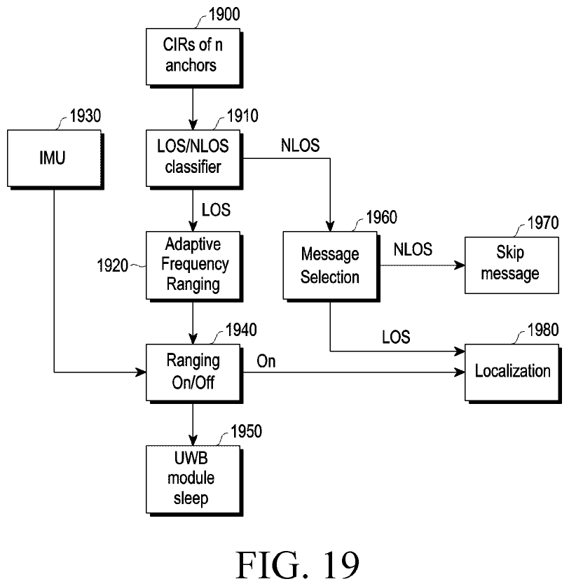

FIG. 19 is a diagram illustrating a configuration of a user device that is capable of reducing power consumption based on LOS/NLOS classification according to an embodiment of the disclosure.

Referring to FIG. 19, the user device may include at least one of a CIR collector module 1900 (CIRs of n anchors), an LOS/NLOS classifier module 1910, an adaptive frequency ranging module 1920, an IMU sensor 1930, a ranging on/off module 1940, a UWB sleep module 1950, a message selection module 1960, a message skip module 1970 (skip message), and a localization module 1980).

According to an embodiment, some of the above-described components may be omitted or an additional component may be further included. According to an embodiment, two or more components among the above-described components may be combined into a single component. According to an embodiment, the whole or part of the above-described components may be embodied by a single processor (or controller).

The CIR collector module 1900 may collect CIR data from at least one UWB signal received via a UWB antenna (e.g., 810) of FIG. 8), and may generate effective CIR data from the collected CIR data. The effective CIR data may include effective CIR values for each UWB signal.

The LOS/NLOS classifier module 1910 may classify whether a UWB signal is an LOS signal or an NLOS signal by using an LOS/NLOS classification method based on UWB CIR data (e.g., the above-described LOS/NLOS classification method). The LOS/NLOS classification module 1910 may determine whether a DL-TDoA positioning environment is an LOS environment or an NLOS environment by using UWB signals in the DL-TDoA positioning environment.

When a result of the determination by the LOS/NLOS classifier module 1910 shows that the DL-TDoA positioning environment is an LOS environment, the adaptive frequency ranging module 1920 may adjust a ranging frequency via adaptive ranging skipping and may reduce power associated with the user device.

According to an embodiment, the adaptive frequency ranging module 1920 may change a ranging frequency based on a distance (d) between the user device and a gate and a distance value (dₐᵣₑₐ) based on a gate access area. According to an embodiment, the adaptive frequency ranging module 1920 may calculate an adaptive ranging frequency using the above-described Equation 2.

According to an embodiment, the adaptive frequency ranging module 1920 may change a ranging frequency based on a distance (d) between the user device and the gate, a distance value (dₐᵣₑₐ) based on the gate access area, an acceleration value (aₘ) measured by the IMU sensor, and a threshold value (aₜₕ) associated with an acceleration. According to an embodiment, the adaptive frequency ranging module 1920 may calculate an adaptive ranging frequency using the above-described Equation 5.

The IMU sensor 1930 may be an inertial measurement device, and may be configured as at least one of an acceleration sensor, an angular velocity sensor (gyroscope), or a geomagnetic sensor (magnetometer). The IMU sensor 1930 may measure an acceleration value (aₘ) in order to identify whether the user device is moving.

The ranging on/off module 1940 may turn on or off a ranging process based on an adaptive ranging frequency received from the adaptive frequency ranging module 1920, and an acceleration value (aₘ) received from the IMU sensor 1930. According to an embodiment, when the ranging on/off module 1940 turns on a ranging process, the localization module 1980 may perform DL-TDoA localization.

The UWB sleep module 1950 may switch a UWB module of the user device into a sleep mode in response to an on/off command of the ranging on/off module 1940.

When a result of the determination by the LOS/NLOS classifier module 1910 shows that the DL-TDoA positioning environment is an NLOS environment, the message selection module 1960 may select n UWB signals to be used for positioning of the user device among a plurality of UWB signals received from UWB anchors, in order to increase accuracy of the positioning of the user device. According to an embodiment, the message selection module 1960 may utilize only 4 UWB signals having high p(LOS) among the plurality of UWB signals when 3D positioning with respect to the user device is performed. According to an embodiment, the message selection module 1960 may utilize only 3 UWB signals having high p(LOS) among the plurality of UWB signals, when 2D positioning with respect to the user device is performed.

The message selection module 1960 may select n UWB signals to be used for positioning of the user device among the plurality of UWB signals, and may determine whether the DL-TDoA positioning environment where the n UWB signals are received is an LOS environment or an NLOS environment, based on an average (^{p̅}) of LOS probabilities of the n UWB signals and a threshold value (pₜₕ).

When a result of the determination by the message selection module 1960 shows that the DL-TDoA positioning environment where the n UWB signals are received is an NLOS environment, the message skip module 1970 may skip processing of the corresponding UWB signals in order to prevent positioning from being performed based on inaccurate signals.

When the result of the determination by the message selection module 1960 shows that the DL-TDoA positioning environment where the n UWB signals are received is an LOS environment, the localization module 1980 may perform DL-TDoA localization.

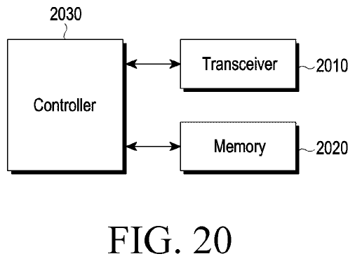

FIG. 20 is a diagram illustrating a structure of an electronic device according to an embodiment of the disclosure.

In the embodiment of FIG. 20, the electronic device may be a user's electronic device (user device) or a server.

Referring to FIG. 20, the electronic device may include a transceiver 2010, a controller 2020, and a storage 2030. In the disclosure, a controller may be defined as a circuit or application-specific integrated circuit, or at least one processor.

The transceiver 2010 may perform signal transmission or reception with another UWB device. The transceiver 2010, for example, may receive a UWB signal from another UWB device.

The controller 2020 may control the overall operation of the electronic device according to an embodiment proposed in the disclosure. For example, the controller 2020 may control a signal flow in blocks in order to perform operations according to the described flowchart. Specifically, the controller 2020, for example, may control the operation of the electronic device which has been described with reference to FIGS. 1 to 19.

The controller 2020 may identify an average of line of sight (LOS) probabilities for a plurality of received UWB signals. The controller 2020 may compare the average of LOS probabilities of the plurality of received UWB signals with a first threshold value, and may determine whether the DL-TDoA environment is an LOS environment based on a comparison result. When it is determined that the DL-TDoA environment is the LOS environment, the controller 2020 may adaptively adjust a ranging frequency that the electronic device uses for ranging. Each of the plurality of received UWB signals may include a UWB message for DL-TDoA positioning.

When the average of the LOS probabilities of the plurality of received UWB signals is greater than the first threshold value, the controller 2020 may determine that the DL-TDoA environment is the LOS environment. When the average of the LOS probabilities of the plurality of received UWB signals is less than the first threshold value, the controller 2020 may determine that the DL-TDoA environment is the NLOS (non-LOS) environment.

When the DL-TDoA environment is determined as the NLOS environment, the controller 2020 may perform positioning with respect to the electronic device based on n UWB signals having high LOS probabilities among the plurality of received UWB signals.

When the DL-TDoA environment is determined as the LOS environment, the controller 2020 may adjust the ranging frequency based on a first value corresponding to a distance between the electronic device and a gate, and a second value based on a gate access area. When the first value is greater than the second value, the controller 2020 may adjust the ranging frequency. When the first value is less than the second value, the controller 2020 may not adjust the ranging frequency.

When the DL-TDoA environment is determined as the LOS environment, the controller 2020 may adjust the ranging frequency based on a distance between the electronic device and a gate, a value based on a gate access area, an acceleration value of the electronic device, and a second threshold value for the acceleration value. When the acceleration value of the electronic device is greater than the second threshold value, the controller 2020 may determine that the electronic device is moving.

The storage 2030 may store at least one of information transmitted or received via the transceiver 2010, and information generated via the controller 2020. For example, the storage 2030, for example, may store information and data related to a UWB signal with reference to FIGS. 1 to 19.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

1. A method of an electronic device, comprising:
obtaining first predicted data for classifying whether a signal corresponding to a UWB channel impulse response (UWB CIR) is a line of signt (LOS) signal or a non-LOS (NLOS) signal based on UWB CIR data, by using a trained first convolutional neural network (CNN) model;
in case that the signal is classified as the LOS signal, obtaining second predicted data for classifying a pose based on sensor data corresponding to the UWB CIR data, by using a trained second CNN model;
in case that the signal is classified as the NLOS signal, obtaining third predicted data for classifying a pose based on sensor data corresponding to the UWB CIR data, by using a trained third CNN model;
performing filtering of at least two of the first predicted data, the second predicted data, and the third predicted data by using a first filtering scheme; and
classifying the pose based on the filtered data,
wherein the second CNN model is trained using sensor data associated with the LOS signal, and the third CNN model is trained using sensor data associated with the NLOS signal.

2. The method of claim 1, wherein the classifying of the pose comprises:
in case that the signal is classified as the LOS signal, classifying, as the pose, one of at least one pose associated with the LOS signal based on the filtered first predicted data and the filtered second predicted data.

3. The method of claim 2, wherein the classifying of the pose comprises:
in case that the signal is classified as the NLOS signal, classifying, as the pose, one of at least one pose associated with the NLOS signal based on the filtered first predicted data and the filtered third predicted data.

4. The method of claim 3, wherein the first filtering scheme is a moving average filter scheme.

5. The method of claim 1, wherein the sensor data is obtained from an inertial measurement unit (IMU) sensor.

6. The method of claim 1, wherein the UWB CIR data comprises effective CIR data obtained by removing noise from CIR data obtained based on UWB signals for downlink-time difference of arrival (DL-TDoA) ranging, or comprises effective CIR data obtained by removing noise from CIR data obtained based on UWB signals for double sided-two way ranging (DS-TWR) ranging.

7. An electronic device comprising:
a transceiver; and
a controller connected to the transceiver,
wherein the controller is configured to:
obtain first predicted data for classifying whether a signal corresponding to a UWB channel impulse response (CIR) is a line of signt (LOS) signal or a non-LOS (NLOS) signal based on UWB CIR data, by using a trained first convolutional neural network (CNN) model;
in case that the signal is classified as the LOS signal, obtain second predicted data for classifying a pose based on sensor data corresponding to the UWB CIR data, by using a trained second CNN model;
in case that the signal is classified as the NLOS signal, obtain third predicted data for classifying a pose based on sensor data corresponding to the UWB CIR data, by using a trained third CNN model;
perform filtering of at least two of the first predicted data, the second predicted data, and the third predicted data by using a first filtering scheme; and
classify the pose based on the filtered data,
wherein the second CNN model is trained using sensor data associated with the LOS signal and the third CNN model is trained using sensor data associated with the NLOS signal.

8. The electronic device of claim 7, wherein the controller is further configured to classify one of at least one pose associated with the LOS signal as the pose, based on the filtered first predicted data and the filtered second predicted data in case that the signal is classified as the LOS signal.

9. The electronic device of claim 8, wherein the controller is further configured to classify one of at least one pose associated with the NLOS signal as the pose, based on the filtered first predicted data and the filtered third predicted data in case that the signal is classified as the NLOS signal.

10. The electronic device of claim 9, wherein the first filtering scheme is a moving average filter scheme.

11. The electronic device of claim 7, wherein the sensor data is sensor data obtained from an inertial measurement unit (IMU) sensor.

12. The electronic device of claim 7, wherein the UWB CIR data comprises effective CIR data obtained by removing noise from CIR data obtained based on UWB signals for downlink-time difference of arrival (DL-TDoA) ranging, or effective CIR data obtained by removing noise from CIR data obtained based on UWB signals for double sided-two way ranging (DS-TWR) ranging.
